(19) United States
(12) Patent Application Publication
(10) Pub. No.: US 2016/0378200 A1
(43) Pub. Date: Dec. 29, 2016

(54) TOUCH INPUT DEVICE, VEHICLE COMPRISING THE SAME, AND METHOD FOR CONTROLLING THE SAME

(71) Applicant: HYUNDAI MOTOR COMPANY, Seoul (KR)

(72) Inventors: Jeong-Eom LEE, Yongin-Si (KR); Jungsang MIN, Seoul (KR); GI BEOM HONG, Bucheon-Si (KR); Sihyun JOO, Seoul (KR)

(73) Assignee: HYUNDAI MOTOR COMPANY

(21) Appl. No.: 14/939,843

(22) Filed: Nov. 12, 2015

(30) Foreign Application Priority Data
Jun. 25, 2015 (KR) 10-2015-0090325

(51) Int. Cl. G06F 3/023; G06F 3/041; G06F 3/0488; G06F 3/0354

(52) U.S. Cl. CPC G06F 3/0236; G06F 3/03547; G06F 3/0416; G06F 3/04883

(57) ABSTRACT

A touch input device includes a protrusion unit protruding from a mounting surface and receiving a touch signal from a user. A recess unit is disposed inside the protrusion unit. A controller is configured to determine whether to input or delete a character in accordance with an input direction of the touch signal.

### CROSS-REFERENCE TO RELATED APPLICATION(S)

This application claims the benefit of priority to Korean Patent Application No. 10-2015-0090325, filed on Jun. 25, 2015 in the Korean Intellectual Property Office, the disclosure of which is incorporated herein by reference.

### TECHNICAL FIELD

The present disclosure relates to a touch input device through which a user inputs a touch signal, a vehicle including the same, and a method for controlling the touch input device,

### BACKGROUND

With the recent advance of electronic communication technology, various electronic devices have been developed. User convenience in manipulation and fine design have been emphasized in these electronic devices. In accordance with this trend, input devices such as keyboards or keypads have been diversified.

A touch input device is one of the input devices and enables an interface between the information communication apparatus using various display devices and the user via an input tool, such as a user's finger or a touch pen, in contact with or in proximity to a touch pad or touchscreen.

Due to ease of use regardless of age and gender by simply touching the input device, such as a finger or touch pen, the touch input device has been applied in various devices from automated teller machines (ATMs), personal digital assistants (PDAs), to mobile phones in banks, government and public offices, tourism, and traffic guidance.

Recently, efforts to apply the touch input device to health or medical products and vehicles have been carried out. Since the touch input device is used in touchscreens or separately used from a display device, utilization of the touch input device has been increased.

### SUMMARY

An aspect of the present inventive concept provides a touch input device configured to input or correct a character by using a touch signal while staring at the road or a screen, a vehicle including the same, and a method for controlling the touch input device,

Additional aspects of the disclosure will be set forth in part in the description which follows and will be obvious in part from the description, or may be learned by practice of the disclosure.

In accordance with an embodiment of the present inventive concept, a touch input device includes a protrusion unit protruding from a mounting surface and receiving a touch signal from a user. A recess unit is disposed inside the protrusion unit. A controller is configured to determine whether to input or delete a character in accordance with an input direction of the touch signal.

When the touch signal is input toward a first position which is closer to the center of the recess unit, the controller may determine the touch signal as a character input.

When a pointer corresponding to the touch signal moves toward the first position and is then detached from the touch input device, the controller may determine the movement of the pointer as the character input.

When the pointer moves toward the first position and then moves to a second position which is farther from the center of the recess unit, the controller may determine the movement of the pointer as a cancellation of the character input.

When the touch signal is input toward a second position, the controller may determine the touch signal as a character deletion.

When a pointer corresponding to the touch signal moves toward the second position and is then detached from the touch input device, the controller may determine the movement of the pointer as the character deletion.

When the pointer corresponding to the touch signal moves toward the second position and then moves to the first position, the controller may determine the movement of the pointer as a cancellation of the character deletion.

The controller may select one of a plurality of characters in accordance with the input direction of the touch signal.

The controller may select one of the plurality of characters in accordance with a direction of a user's rolling gesture.

When the character is selected by the rolling gesture and the touch signal is input toward a first position which is closer to a center of the recess unit, the controller may determine the touch signal as a character input.

The controller may move a cursor displayed on a display device in accordance with the input direction of the touch signal.

The controller may move the cursor displayed on the display device in accordance with the direction of the user's rolling gesture.

When a cursor is placed at the selected character by the rolling gesture and the touch signal is input toward a second position which is farther from the center of the recess unit, the controller may determine the touch signal as a character deletion.

The protrusion unit may have a cylindrical or column shape.

When a touch signal is input from the protrusion unit to the recess unit, the controller may determine the touch signal as a character input.

When the touch signal is input from a second position to a first position which is closer to the center of the recess unit, the controller may determine the touch signal as the character input.

In accordance with another embodiment of the present inventive concept, a vehicle includes a touch input device including a protrusion unit protruding from a mounting surface and receiving a touch signal from a user and a recess unit disposed inside the protrusion unit. A controller is configured to determine whether to input or delete a character in accordance with an input direction of the touch signal.

The vehicle may further include a display device. The controller may operate the display device in accordance with the touch signal input to the touch input device.

When the touch signal is input toward a first position which is closer to the center of the recess unit, the display device may display a character corresponding to the touch signal.

When the touch signal is input toward a second position which is farther from the center of the recess unit, the display device may delete a character corresponding to the touch signal.

In accordance with another embodiment of the present inventive concept, a method for controlling a touch input device includes receiving a touch signal from a user, by a protrusion unit protruding from a mounting surface and a recess unit disposed inside the protrusion unit. Whether to input or delete a character is determined in accordance with an input direction of the touch signal by a controller. The step of determining includes determining, when a pointer corresponding to the touch signal moves toward a first position which is closer to the center of the recess unit and is then detached from the touch input device, the movement of the pointer as a character input.

The step of determining may further includes determining, when the pointer corresponding to the touch signal moves toward the first position and then moves to a second position which is farther from the center of the recess unit, the movement of the pointer as a cancellation of the character input.

### BRIEF DESCRIPTION OF THE DRAWINGS

These and/or other aspects of the disclosure will become apparent and more readily appreciated from the following description of the embodiments, taken in conjunction with the accompanying drawings.

FIG. 1 is a perspective view illustrating a touch input device according to a first embodiment of the present inventive concept.

FIG. 2 is a plan view illustrating the touch input device according to the first embodiment of the present inventive concept.

FIG. 3 is a cross-sectional view taken along line A-A of FIG. 2.

FIGS. 4 to 6 are diagrams for describing methods of manipulating the touch input device according to the first embodiment of the present inventive concept illustrating a press input (FIG. 4), a swipe input (FIG. 5), and a character input (FIG. 6).

FIG. 7 is a diagram for describing a method of selecting a character using a protrusion unit.

FIG. 8 is a diagram illustrating a character selected via a movement described with reference to in FIG. 7 from a table of characters displayed on a display device.

FIGS. 9A to 9C are diagrams for describing methods of inputting a character using a protrusion unit and a touch unit.

FIG. 10 is a diagram illustrating a character input a movement described with reference to FIGS. 9A to 9C.

FIGS. 11 and 12 are diagrams exemplarily illustrating screens displayed by a display device in response to a rolling gesture of a user.

FIGS. 13A to 13B are diagrams for describing methods of deleting a character by manipulating the touch input device.

FIG. 14 is a diagram illustrating a character deleted via a movement described with reference to FIGS. 13A to 13B.

FIG. 15 is a perspective view illustrating a touch input device according to a second embodiment of the present inventive concept.

FIG. 16 is a cross-sectional view illustrating the touch input device according to the second embodiment of the present inventive concept.

FIG. 17 is a plan view illustrating the touch input device according to the second embodiment for describing a rolling gesture input, as a touch gesture input.

FIG. 18 is a cross-sectional view illustrating a touch input device according to a third embodiment of the present inventive concept.

FIG. 19 is a diagram illustrating a trace of a finger when a user makes a vertical gesture.

FIG. 20 is a diagram illustrating a trace of a finger when a user makes a horizontal gesture.

FIG. 21 is a cross-sectional view illustrating a touch input device according to a fourth embodiment of the present inventive concept.

FIG. 22 is a plan view illustrating a touch input device according to a fifth embodiment of the present inventive concept.

FIG. 23 is a cross-sectional view taken along line B-B of FIG. 22.

FIG. 24 is a cross-sectional view illustrating a touch input device according to a sixth embodiment of the present inventive concept.

FIG. 25 is a perspective view illustrating a touch input device according to a seventh embodiment of the present inventive concept.

FIG. 26 is a perspective view illustrating the touch input device according to the seventh embodiment of the present inventive concept for describing manipulation thereof.

FIG. 27 is a flowchart for describing a method of inputting a character by using a touch input device according to the present inventive concept.

FIG. 28 is a flowchart for describing a method of deleting a character by using a touch input device according to the present inventive concept.

FIG. 29 is an interior view of a vehicle including the touch input device according to the first embodiment of the present inventive concept.

FIG. 30 is a perspective view illustrating a gear box including the touch input device according to the first embodiment of the present inventive concept.

### DETAILED DESCRIPTION

Reference will now be made in detail to embodiments of the present inventive concept, examples of which are illustrated in the accompanying drawings, wherein like reference numerals refer to like elements throughout. In the drawings, the same or similar elements are denoted by the same reference numerals even though they are depicted in different drawings. In the following description of the present disclosure, a detailed description of known functions and configurations incorporated herein will be omitted when it may make the subject matter of the present disclosure rather unclear. In addition, terms in the following description, such as first, second, etc., are used to discriminate one element from other elements, but do not limit such elements.

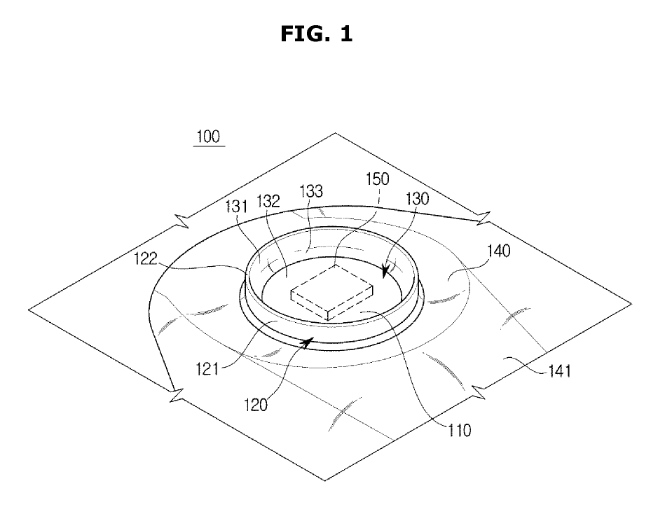

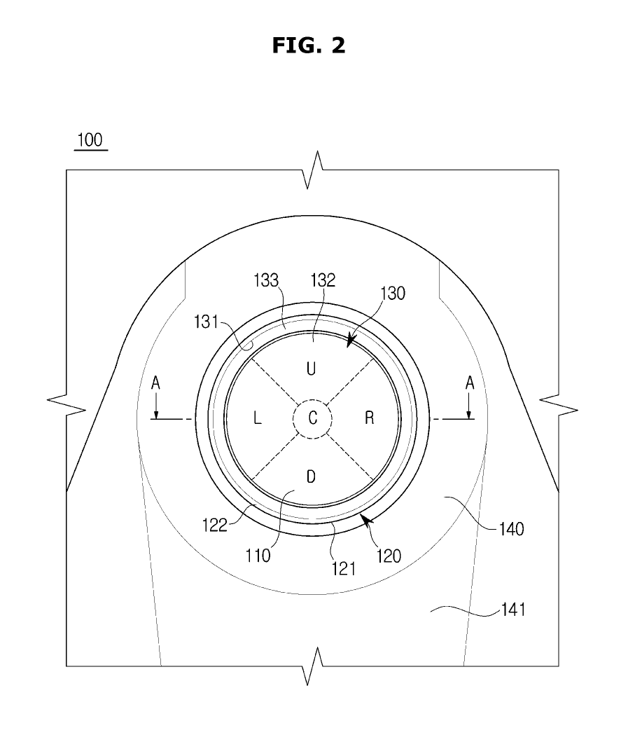

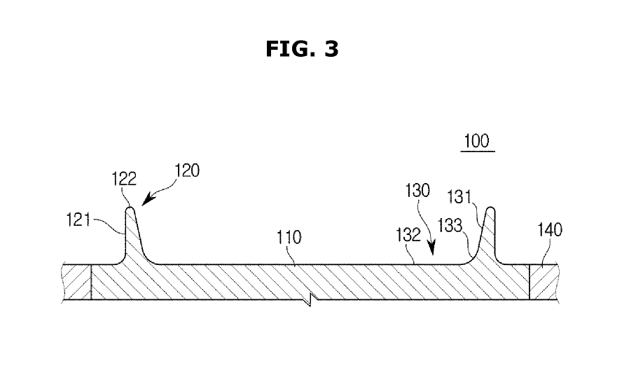

FIG. 1 is a perspective view illustrating a touch input device according to a first embodiment of the present inventive concept. FIG. 2 is a plan view illustrating the touch input device according to the first embodiment of the present inventive concept. FIG. 3 is a cross-sectional view taken along the line A-A of FIG. 2.

A touch input device 100 according to the first embodiment is mounted on a mounting surface 140 and includes a protrusion unit 120 protruding from the mounting surface 140, a recess unit 130 recessed inward from the protrusion unit 120, and a touch unit 110 disposed on a bottom surface of the recess unit 130. The protrusion unit 120, the recess unit 130, and the touch unit 110 may be integrated or coupled to form a single structure.

The mounting surface 140 may surround the touch input device 100 and may be formed of a different material from the touch input device 100.

The mounting surface 140 that is a reference surface on which the touch input device 100 is mounted may be a planar surface. However, the mounting surface 140 is not limited thereto and may also be a convex or concave surface.

Although not illustrated in the drawings, an input unit such as a key button or a touch button surrounding the touch input device 100 may be disposed on the mounting surface 140. A user may input a touch signal through the touch input device 100 or may input a signal by using a button mounted on the mounting surface 140 around the touch input device 100.

The protrusion unit 120 is formed to protrude from the mounting surface 140. The protrusion unit 120 may have a circular horizontal cross-section. For example, the protrusion unit 120 may have a cylindrical or column shape. However, the shape of the protrusion unit 120 may be modified into various other forms as necessary.

The protrusion unit 120 includes an outer side portion 121 connected to the mounting surface 140 and a ridge portion 122 connected to the outer side portion 121. For example, the outer side portion 121 having a column shape and the ridge portion 122 having a ring shape are illustrated in the drawings.

The recess unit 130 is formed inward to be recessed from the ridge portion 122 of the protrusion unit 120. In this regard, the recessed shape may include not only a curved shape but also a slanted or stepped shape.

The recess unit 130 may have an opening with a circular horizontal cross-section. For example, the recess unit 130 may have a concave shape with a circular opening starting from the ridge portion 122 of the protrusion unit 120.

The recess unit 130 includes an inner side portion 131 connected to the ridge portion 122 and a bottom portion 132 on which the touch unit 110 is disposed. For example, the inner side portion 131 having a shape of the inner side of a column and the bottom portion 132 having a circular planar shape are illustrated in the drawings.

The recess unit 130 may further include a connection portion 133 connecting the inner side portion 131 with the bottom portion 132. For example, the connection portion 133 may have a slanted surface or a curved surface with a negative curvature. Here, the negative curvature refers to an inwardly concave surface viewed from the outside of the recess unit 130.

The bottom portion 132 may include the touch unit 110 which receives a user's touch input signal.

The touch unit 110 may include a touch pad through which a signal is input when a user contacts or approaches the touch pad by using a pointer such as a finger or a touch pen. The user may input a desired instruction or command by making a predetermined touch gesture on the touch unit 110.

The touch pad may include a touch film or a touch sheet including a touch sensor. The touch pad may also include a touch panel that is a display apparatus having a touchscreen.

“Proximity touch” refers to recognizing a position of a pointer located in the proximity of the touch pad without being in contact with the touch pad, and “Contact touch” refers to recognizing a position of the pointer in contact with the touch pad. In this regard, a position where the proximity touch is performed may be a position vertically corresponding to the touch pad when the pointer approaches the touch pad.

The touch pad may be a resistive, an optical, a capacitive, an ultrasonic, or a pressure sensing-type touch pad. That is, various other known touch pads may also be used.

The mounting surface 140 may further include a wrist support portion 141 located under the mounting surface 140 to support a wrist of the user. The wrist support portion 141 may be located higher than the touch unit 110. Thus, when the user makes a gesture on the touch unit 110 by using a finger while the wrist is supported by the wrist support portion 141, the wrist of the user may be prevented from uncomfortably being bent upward. As a result, the wrist support portion 141 may prevent musculoskeletal diseases of the user and allow the user to comfortably make the gesture.

The touch input device 100 may include a controller 150 that recognizes a touch input signal input to the touch unit 110 and transmits commands to various devices after analyzing the touch input signal.

The touch input signal may include a tab signal acquired when the pointer contacts a predetermine location of the touch unit 110 and a gesture signal acquired when the pointer moves in a contact state with the touch unit 110.

When the pointer contacts a divided region of the touch unit 110, the controller 150 may recognize the contact as a tab signal and execute a predetermined command corresponding to the divided region.

Referring to FIG. 2, the touch unit 110 may be divided into a central region and an outer region. For example, when the touch unit 110 has a circular shape, the central region may be formed as a smaller circle, and the outer region may be formed as a greater circle excluding the central region. The touch unit 110 may also be divided into a plurality of regions.

The outer region of the touch unit 110 may be divided into up/down/left/right regions. For example, the touch unit 110 may be divided into the four regions, each having 90 degrees. The touch unit 110 may also be divided into a plurality of regions having smaller degrees.

In FIG. 2, the circular touch unit 110 includes a central region C having a smaller circular shape, and outer regions U, D, L, and R which are formed by dividing a circumference of the greater circle into four equal parts, each of which has 90 degrees. For example, when the pointer taps the central regions C, the controller 150 may execute a command to select a menu at a position where a cursor of a screen is located. When the pointer taps the up U, down D, left L, or right R regions, the controller 150 may execute a command to move the cursor of the screen upward, downward, leftward, or rightward.

The controller 150 may include a memory to store programs and data used to control the touch input device 100 and a display device and a processor to create a control signal in accordance with the programs and data stored in the memory. Although the touch input device 100 includes the controller 150 herein, the controller 150 may be disposed outside the touch input device 100. For example, when a vehicle includes the touch input device 100, the controller 150 may also be disposed outside the touch input device 100 in the vehicle and control various other constituent elements in addition to the touch input device 100.

The divided regions of the touch unit 110 may be indicated in a visibly recognizable manner. For example, the outer regions U, D, L, and R of the touch unit 110 may be indicated using arrows. The central region C of the touch unit 110 may be indicated using a color different from those of the outer regions U, D, L, and R. Alternatively, an LED lamp may be installed in any one of the central region C and the outer regions U, D, L, and R of the touch unit 110.

The touch regions of the touch unit 110 may not be visibly distinguished from each other. When the user touches a central region of the touch unit 110, the controller 150 may recognize that the central region C is touched, and when the user touches an upper region, the controller 150 may recognize that the upper region U of the outer region is touched.

Alternatively, the touch regions of the touch unit 110 may be distinguished by tactile sense. The central region C of the touch unit 110 may have a different surface roughness or a different temperature than those of the outer regions U, D, L, and R.

When the pointer moves in the contact state with the touch unit 110, the controller 150 may recognize the movement as a gesture signal, determine a shape of the gesture by tracking the movement of the pointer, and execute a predetermined command in accordance with the shape of the gesture.

For example, the controller 150 may move the cursor or menu displayed on the display device according to a trace of the pointer moving on the touch unit 110. That is, when the pointer moves downward, the controller 150 may move the cursor displayed on the display device in the same direction or a previously selected main menu may be shifted to a sub menu.

The controller 150 may analyze the trace of the pointer, correspond the analyzed trace to a predetermined gesture, and execute a command corresponding to the gesture. When the pointer performs a flicking, swiping, rolling, circling, spinning, or tap operation, the controller 150 may recognize the gesture and execute a command corresponding to the gesture. Further, the user may make a gesture using various other touch input methods.

Here, the flicking or swiping operation refers to a touch input method in which the pointer moves on the touch unit 110 in one direction in the contact state with the touch unit 110 and then is detached therefrom. The rolling operation refers to a touch input method in which the pointer moves along the arc of a circle about the center of the touch unit 110. The circling or spinning operation refers to a touch input method in which the pointer moves in a circular motion about the center of the touch unit 110. The tap operation refers to a touch input method in which the pointer taps the touch unit 110. The tap operation may include consecutive multiple taps.

In addition, the gesture input may be performed by using a multi-pointer input method. The multi-pointer input method refers to a method of inputting a gesture by using two pointers in a state that the two pointers simultaneously or sequentially touch a touch panel. For example, a gesture may be made in a state that two fingers touch the touch unit 110. The user may input various commands by making a gesture by a multi-pointer input method in addition to a single-pointer input method.

The user may also perform a gesture input by writing characters, numbers, or preset symbols. For example, the user may write or draw consonants/vowels of the English alphabet, Arabic numerals, arithmetic symbols, or the like. The user may reduce an input time and provide a more instinctive interface by directly inputting a desired character or number.

The touch unit 110 disposed on the bottom portion 132 has been described above. However, the touch unit 110 may also be disposed at various other positions of the protrusion unit 120 and the recess unit 130. As the touch unit 110 is disposed at more positions, a variety of commands can be inputted.

The protrusion unit 120 may also be touch-inputtable. For example, the user may input a touch signal by turning the outer side portion 121 of the protrusion unit 120 in a state of gripping the outer side portion 121. Since the protrusion unit 120 is fixed to the mounting surface 140, it does not rotate physically, but the controller 150 may recognize a sliding gesture of a hand of the user, as the pointer, in a contact state with the outer side portion 121.

The touch-inputtable outer side portion 121 of the protrusion unit 120 may correspond to a dial input. A dial, which is mounted on a knob, or the like and physically rotates, may be used to adjust a volume, or the like in accordance with the degree of rotation. According to the present disclosure, when the outer side portion 121 of the protrusion unit 120 is touch-inputtable, the user may have the same results as those of a dial by turning the outer side portion 121 in a state of gripping the outer side portion 121.

In addition, the ridge portion 122 of the protrusion unit 120 may be touch-inputtable. In this case, the user may input a rolling gesture by drawing a circle along the ridge portion 122 in a contact state with the ridge portion 122.

The inner side portion 131 or the connection portion 133 of the recess unit 130 may be touch-inputtable.

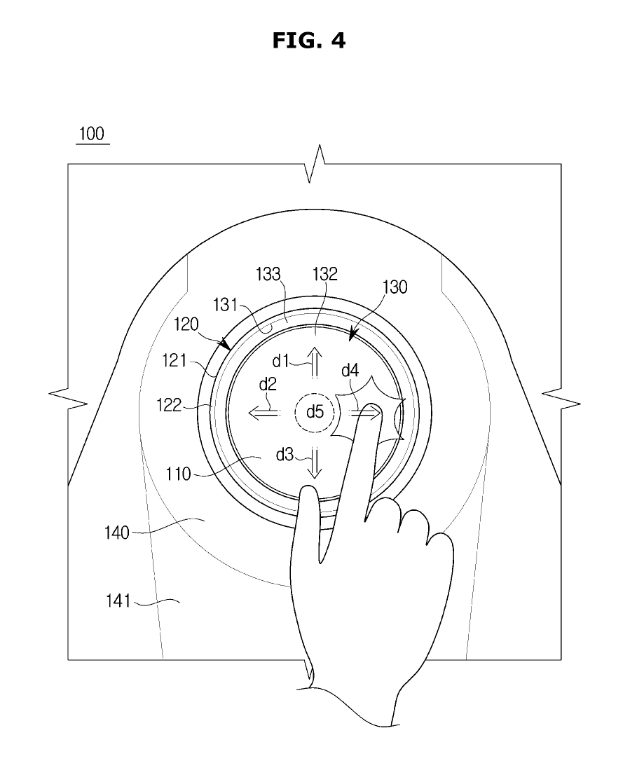

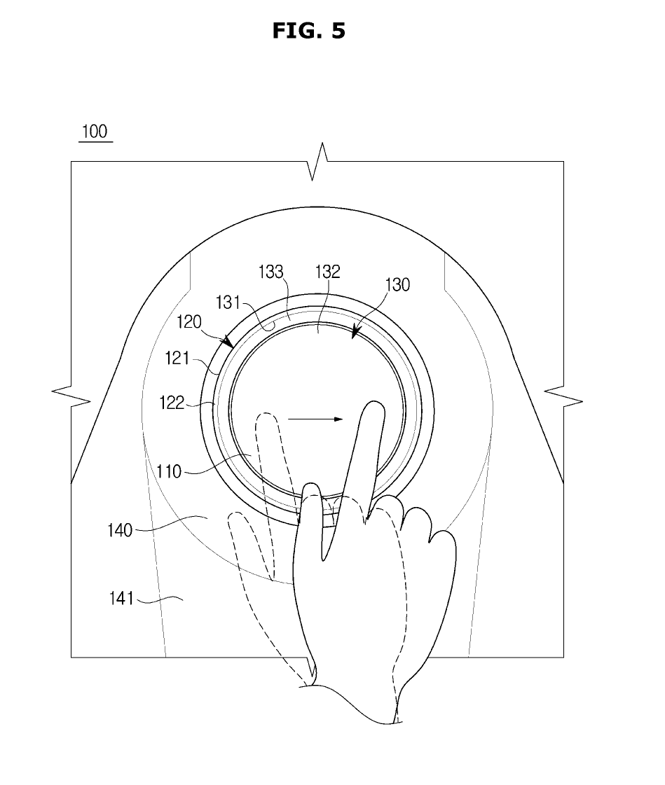

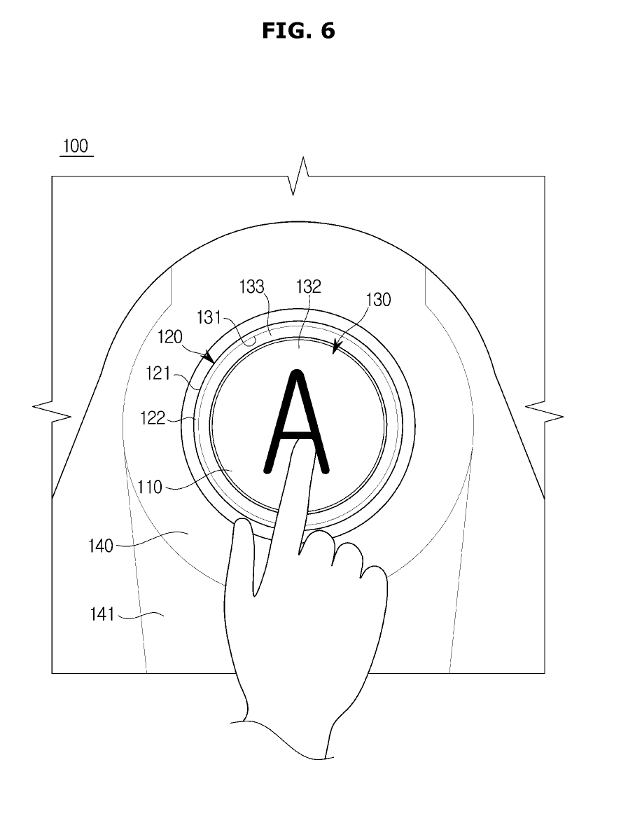

FIGS. 4 to 6 are diagrams describing methods of manipulating the touch input device according to the first embodiment and illustrating a press input (FIG. 4), a swipe input (FIG. 5), and a character input (FIG. 6).

A user may input a preset execution signal by tapping one region of the touch unit 110 according to the aforementioned description. In addition, the touch unit 110 may be performed a pressing operation or a slanting operation. In addition, when the touch unit 110 is flexible, only a portion to which a pressure is applied may be pressed.

The touch unit 110 may be slanted in at least one direction (d1 to d4) with respect to a central axis. For example, the touch unit 110 may be slanted in forward, backward, leftward, and rightward directions d1 to d4 as illustrated in FIG. 4. However, the touch unit 110 may also be slanted in more directions. In addition, when a central region d5 of the touch unit 110 is pressed, the touch unit 110 may be pressed in a balanced state.

The bottom portion 132 on which the touch unit 110 is disposed may move separately from the inner side portion 131. The bottom portion 132 may perform the pressing operation and the slanting or tilting operation. For example, when the user applies a pressure to the touch unit 110, the bottom portion 132 may be pressed at the portion to which the pressure is applied or may be slanted in a direction to which the pressure is applied.

The user may input the preset execution signal by pressing or slanting a portion of the touch unit 110. For example, the user may execute a menu selected by pressing the central region d5 of the touch unit 110. The user may also move a cursor upward by pressing the upward direction dl of the touch unit 110.

A pressing structure of the touch unit 110 may include a button (not shown) installed under the touch unit 110. The button may have a clickable structure. That is, the user may input a touch signal by touching the touch unit 110 and may also input a click signal by simultaneously pressing the touch unit 110.

One button may be disposed under the touch unit 110. In this case, the user may input the click signal by clicking the center of the touch unit 110 or may input the touch signal by tapping the central, up, down, left, and right regions of the touch unit 110.

Alternatively, a plurality of buttons may be disposed under the touch unit 110. For example, a total of 5 buttons may be respectively disposed at the central, up, down, left, and right regions. In this case, the user may input different click signals by clicking the central, up, down, left, and right regions of the touch unit 110 and may also input different touch signals by tapping the central, up, down, left, and right regions of the touch unit 110.

Although not illustrated in the drawings, the touch input device 100 may include various parts related to operation thereof. The touch input device 100 may include structures to enable the pressing operation or slanting operation of the touch unit 110 in five directions d1 to d5. However, these structures are realized by techniques well known in the art, and thus, detailed descriptions thereof will not be given herein.

In addition, the touch input device 100 may include various semiconductor chips and printed circuit boards (PCBs). The semiconductor chips may be mounted on the PCBs and may perform information processing or store data. The semiconductor chips may interpret an electric signal generated in accordance with an external force applied to the touch input device 100, a gesture recognized by the touch unit 110, or manipulation of a button of the touch input device 100. Further, the semiconductor chips may create a predetermined control signal according to the interpretation and transmit the control signal to a controller 150 or a display device of another device.

Referring to FIG. 5, the user may input the preset execution signal by performing a flicking or swiping operation that slides on the touch unit 110. For example, the user may move a menu displayed on the display device to a next menu by sliding the pointer left to right in a contact state with the touch unit 110.

Referring to FIG. 6, the user may input the preset execution signal by writing or drawing a number or a character or making a preset gesture on the touch unit 110. For example, the user may input “A” to an input box of the display device by writing character “A” on the touch unit 110. The user may input a desired character easily and quickly by directly inputting a character on the touch unit 110 compared to selecting the character from a table of characters displayed on the display device.

The user may also select and input the character from the table of characters displayed on the display device by using a combination of the protrusion unit 120 and the touch unit 110 in addition to directly inputting the character to the touch unit 110.

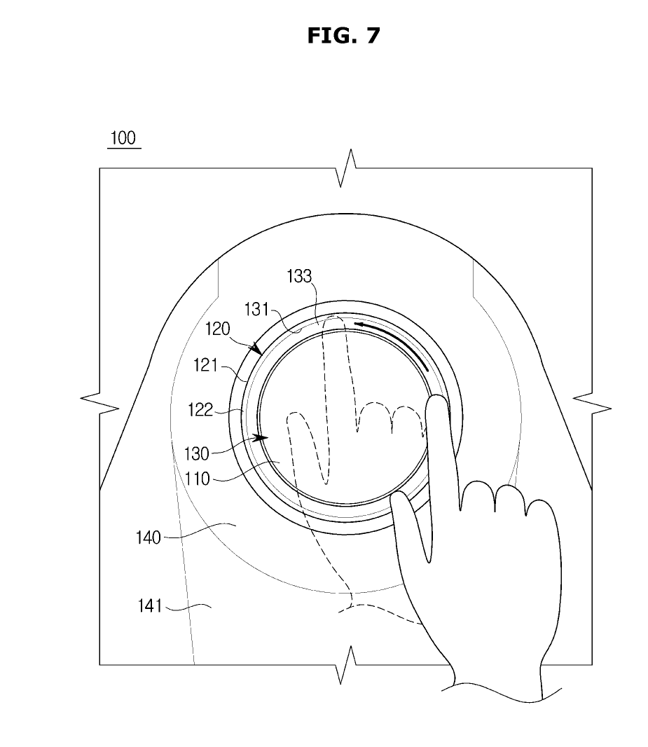

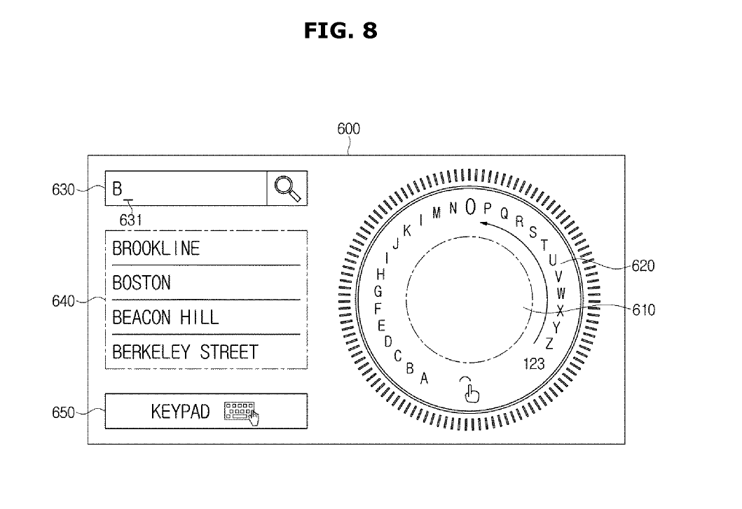

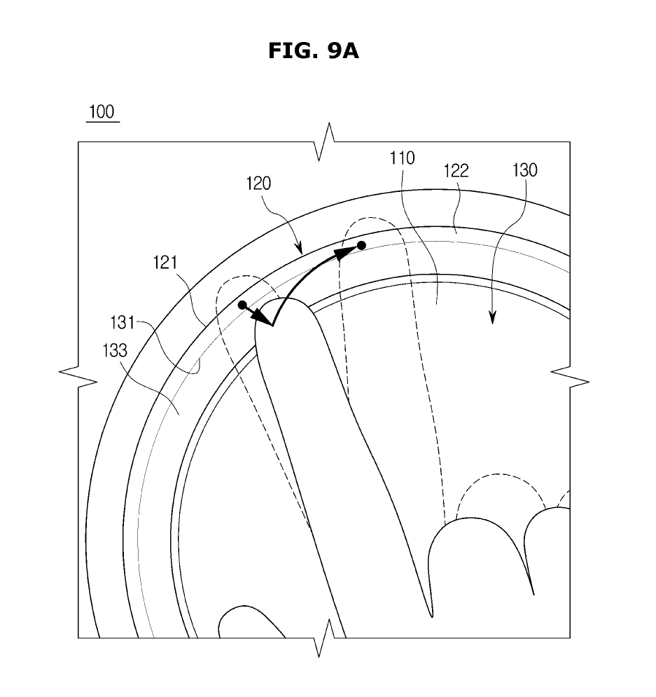

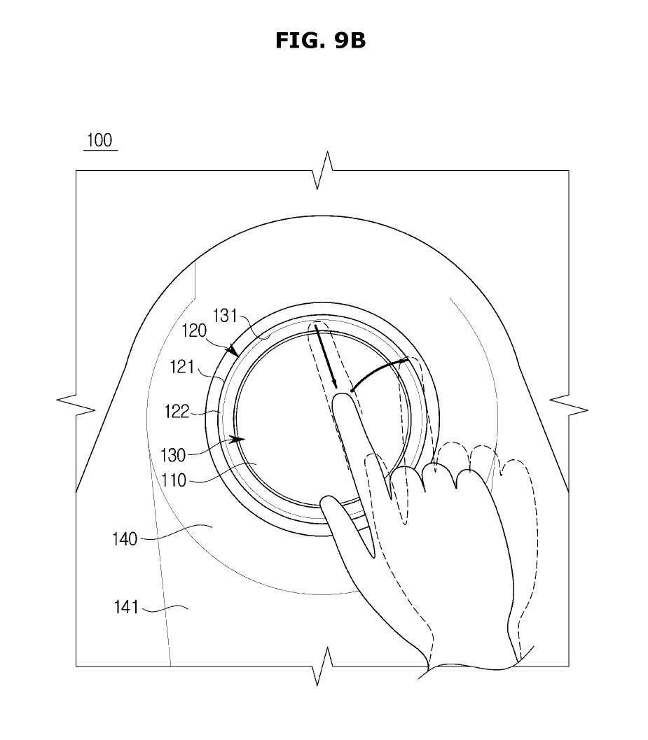

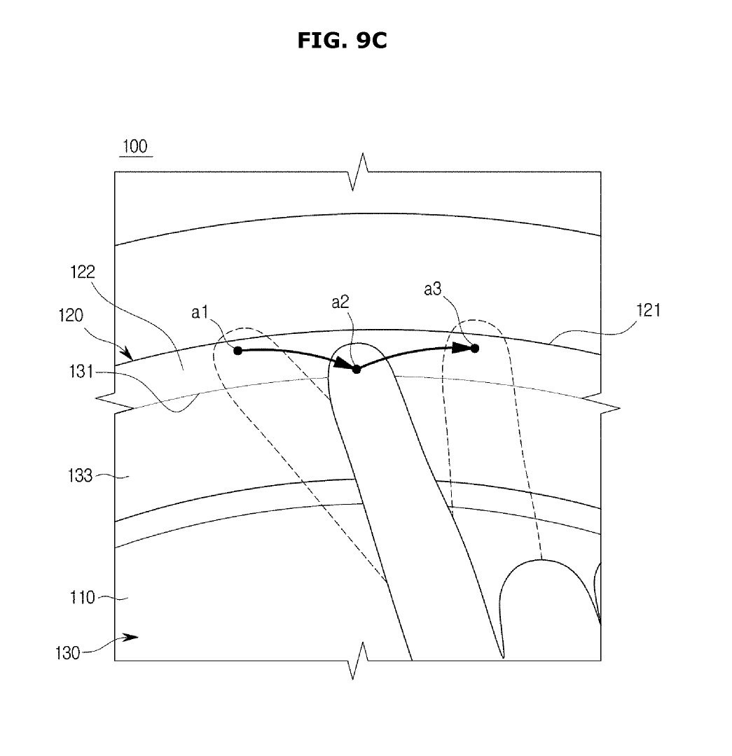

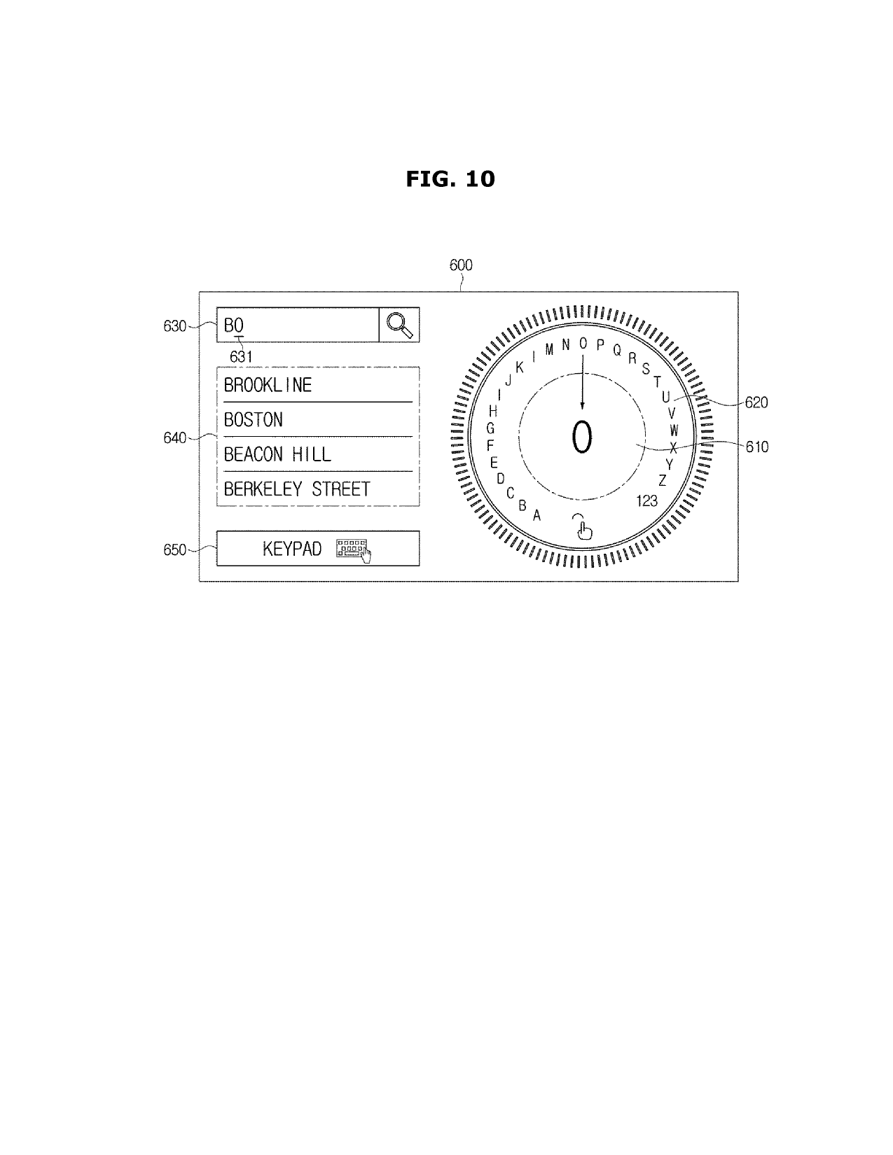

FIG. 7 is a diagram for describing a method of selecting a character using a protrusion unit. FIG. 8 is a diagram illustrating a character selected via a movement described with reference to in FIG. 7 from a table of characters displayed on a display device. FIGS. 9A to 9C are diagrams for describing methods of inputting a character using a protrusion unit and a touch unit. FIG. 10 is a diagram illustrating a character input via a movement described with reference to FIGS. 9A to 9C.

Referring to FIG. 7, the ridge portion 122 of the protrusion unit 120 may be touch-inputtable. The user may make a rolling gesture by drawing a circle along the ridge portion 122 in a contact state with the ridge portion 122.

Referring to FIG. 8, as the rolling gesture is made on the ridge portion 122, one of the characters listed in the table of characters of a character table display region 620 of the display device 600 may be selected.

The user may search for a character inputtable to the character table display region 620 by making the rolling gesture on the ridge portion 122. The controller 150 may move a cursor on the character table display region 620 to correspond to a position of the pointer, select the character (“O” in FIG. 8) at which the cursor is located, and emphasize the character to the user.

Referring to FIGS. 9A to 9C, the user may input a selected character by bringing the pointer into contact with the ridge portion 122, by moving the pointer to an inner portion of the touch input device 100 in a contact state therewith, and by detaching the pointer therefrom (i.e., flicking).

Here, the “inner portion” is located relatively closer to the center of the recess unit 130, and an “outer portion” is located relatively farther from the center of the recess unit 130.

Referring to FIG. 9A, the user may input a character selected by a previous rolling gesture (e.g., “O”) by bringing the pointer into contact with the ridge portion 122, by moving the pointer to the inner side portion 131 of the touch input device in a contact state therewith, and by detaching the pointer from the inner side portion 131. In this case, the controller 150 determines the movement of the pointer to the inner side portion 131 from the ridge portion 122 as an inward movement.

According to another embodiment as illustrated in FIG. 9B, the user may input the character selected by the previous rolling gesture (e.g., “O”) by bringing the pointer into contact with the ridge portion 122, by moving the pointer to the touch unit 110 via the inner side portion 131 of the touch input device in a contact state therewith, and by detaching the pointer from the touch unit 110. In this case, the controller 150 determines the movement of the pointer from the ridge portion 122 to the touch unit 110 via the inner side portion 131 as an inward movement.

According to another embodiment as illustrated in FIG. 9C, when the ridge portion 122 has an appropriate thickness and is divided into two areas, i.e., inner and outer areas, the user may input the character selected by the previous rolling gesture (e.g., “O”) by bringing the pointer into contact with one position a1 in the outer area of the ridge portion 122, by moving the pointer to another position a2 in the inner area of the ridge portion 122 in a contact state therewith, and by detaching the pointer from the position a2. In this case, the controller 150 determines the movement of the pointer from the position a1 of the ridge portion 122 to the position a2 of the ridge portion 122 as an inward movement.

When the user brings the pointer into contact with the ridge portion 122 and moves the pointer to an inner portion of the touch input device, the selected character is displayed in a main display region 610 as illustrated in FIG. 10. When the user detaches the pointer from the inner portion, the selected character is input to the display device 600 and displayed at a cursor position 631 of the keyword display region 630.

When the user brings the pointer into contact with the ridge portion 122, moves the pointer to an inner portion in a contact state therewith, and then moves the pointer to an outer portion in a contact state therewith, the selected character is not input (i.e., cancellation of character input).

Referring back to FIG. 9A, when the user brings the pointer into contact with the ridge portion 122, moves the pointer to the inner side portion 131 of the touch input device in a contact state therewith, and then moves the pointer back to the ridge portion 122 in a contact state therewith (i.e., when the user does not detach the pointer from the inner side portion 131), the character selected by the previous rolling gesture (e.g., “O”) is not input.

Referring back to FIG. 9B, when the user brings the pointer into contact with the ridge portion 122, moves the pointer to the touch unit 110 via the inner side portion 131 of the touch input device in a contact state therewith, and then moves the pointer back to the ridge portion 122 via the inner side portion 131 in a contact state therewith (i.e., when the user does not detach the pointer from the touch unit 110), the character selected by the previous rolling gesture (e.g., “O”) is not input.

Referring back to FIG. 9C, in a state that the ridge portion 122 has an appropriate thickness and is divided into two areas, i.e., inner and outer areas, when the user brings the pointer into contact with one position a1 in the outer area of the ridge portion 122, moves the pointer to another position a2 in the inner area of the ridge portion 122 in a contact state therewith, and then moves the pointer to another position a3 in the outer area of the ridge portion 122 in a contact state therewith (i.e., when the user does not detach the pointer from the position a2), the character selected by the previous rolling gesture (e.g., “O”) is not input.

When a row of characters is displayed in the keyword display region 630, the user may select a character to be corrected by using the touch input device according to the first embodiment in order to correct one of the characters displayed in the keyword display region 630. In this case, the user may start a character correction mode and select one of the characters displayed in the keyword display region 630.

As an example of starting the character correction mode, the user may select the keyword display region 630 by clicking or touching the up, down, left, right, or central region of the touch unit 110, and the controller 150 may start the character correction mode upon selection of the keyword display region 630.

As another example of starting the character correction mode, the user may select the keyword display region 630 by touching the keyword display region 630 on the display device 600 implemented using a touchscreen, and the controller 150 may start the character correction mode upon selection of the keyword display region 630.

The controller 150 may also start the character correction mode by using various other methods, and the method of starting the character correction mode is not limited thereto.

After the character correction mode starts, the user may make a rolling gesture on the ridge portion 122 of the protrusion unit 120 as illustrated in FIG. 7 in order to select one of the characters displayed in the keyword display region 630.

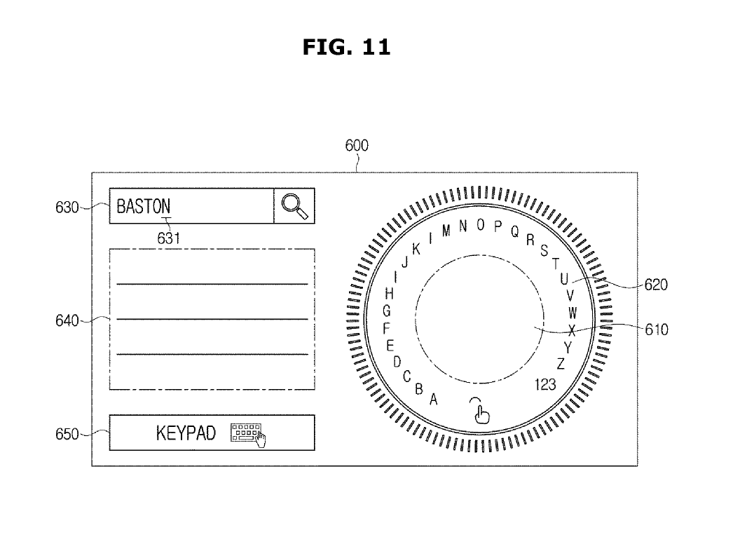

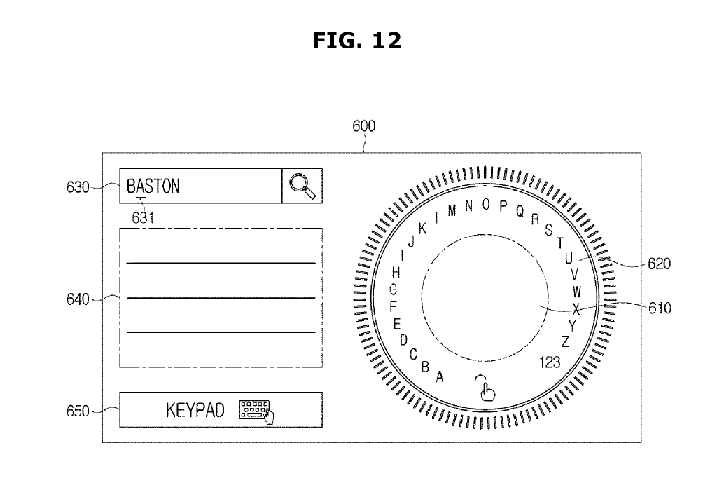

FIGS. 11 and 12 are diagrams exemplarily illustrating screens displayed by a display device in response to a rolling gesture of a user.

Referring to FIG. 11, when a word “BASTON” is displayed in the keyword display region 630n and the cursor 631 is placed under the rightmost character “N”, the user may make a counterclockwise rolling gesture such that the cursor 631 is placed under the character A. The cursor 631 may move leftward in accordance with the rolling gesture as illustrated in FIG. 12.

Although not shown herein, when the user makes a clockwise rolling gesture, the cursor 631 may move rightward.

When the character under which the cursor 631 is placed is selected in accordance with the movement of the cursor 631, the user may delete the selected character by bringing the pointer into contact with the ridge portion 122 and by moving the pointer to an outer portion of the touch input device 100 in a contact state therewith, and detaching the pointer therefrom (i.e., flicking).

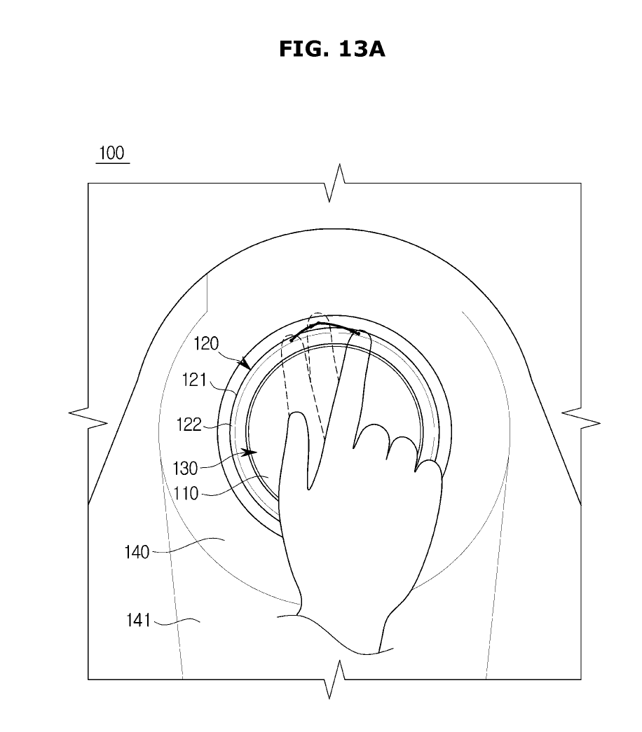

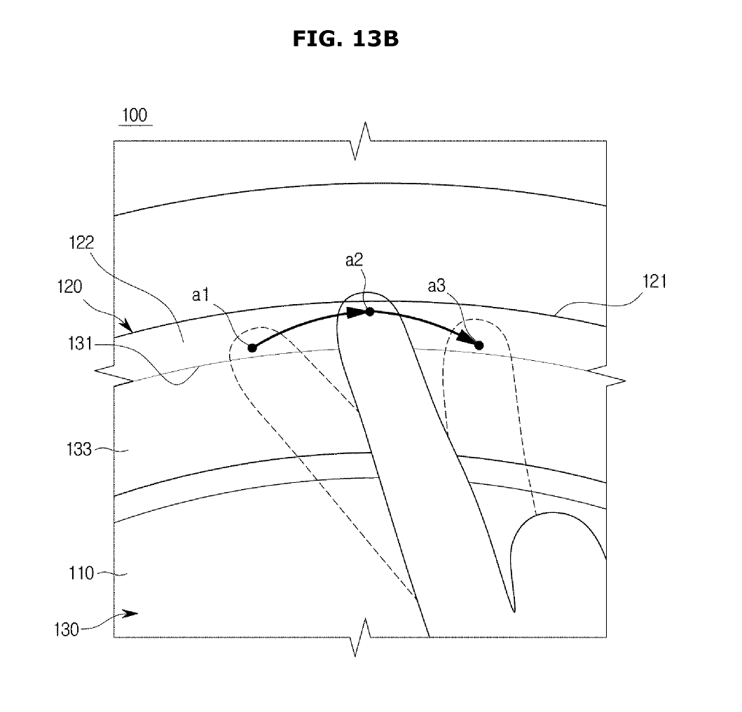

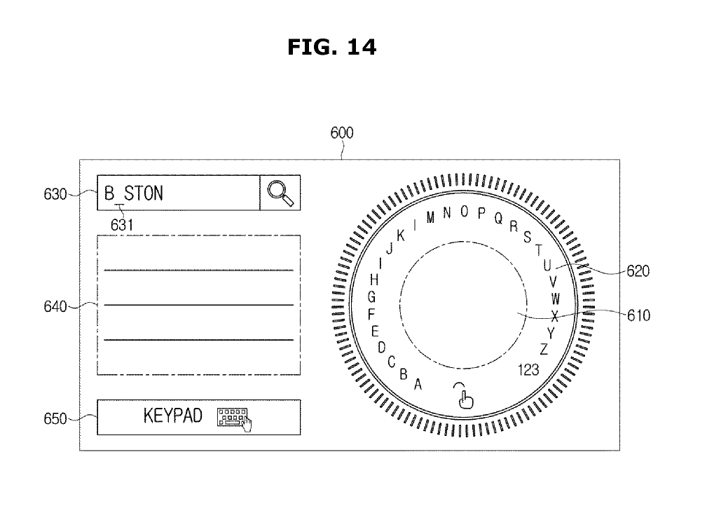

FIGS. 13A and 13B are diagrams describing methods of deleting a character by manipulating the touch input device. FIG. 14 is a diagram illustrating a character deleted via a movement described with reference to FIGS. 13A and 13B.

Referring to FIG. 13A, the user may delete the character selected by the previous rolling gesture (e.g., “A”) by bringing the pointer into contact with the ridge portion 122, by moving the pointer to the outer side portion 121 of the touch input device in a contact state therewith, and by detaching the pointer from the outer side portion 121. In this case, the controller 150 determines the movement of the pointer to the outer side portion 121 from the ridge portion 122 as an outward movement.

According to another embodiment as illustrated in FIG. 13B, when the ridge portion 122 has an appropriate thickness and is divided into two areas, i.e., inner and outer areas, the user may delete the character selected by the previous rolling gesture (e.g., “A”) by bringing the pointer into contact with one position a1 in the inner area of the ridge portion 122, by moving the pointer to another position a2 in the outer area of the ridge portion 122 in a contact state therewith, and by detaching the pointer from position a2. In this case, the controller 150 determines the movement of the pointer from position a1 of the ridge portion 122 to position a2 of the ridge portion 122 as an outward movement.

Referring to FIG. 14, when the user brings the pointer into contact with the ridge portion 122, moves the pointer to the outer portion of the touch input device in a contact state therewith, and then detaches the pointer therefrom, the selected character is deleted from the display device 600. As a result, the character on the cursor 631 in the keyword display region 630 is deleted.

When the user brings into contact with the ridge portion 122, moves the pointer outward in a contact state therewith, and then moves the pointer inward in a contact state therewith, the selected character is not deleted (i.e., cancellation of character deletion).

Referring back to FIG. 13A, when the user brings the pointer into the ridge portion 122, moves the pointer to the outer side portion 121 of the touch input device in a contact state therewith, and then moves the pointer back to the ridge portion 122 in a contact state therewith (i.e., when the user does not detach the pointer from the outer side portion 121), the character selected by the previous rolling gesture (e.g., “A”) is not deleted.

Referring back to FIG. 13B, in a state in which the ridge portion 122 has an appropriate thickness and is divided into two areas, i.e., inner and outer areas, when the user brings the pointer into contact with one position a1 in the inner area of the ridge portion 122, moves the pointer to another position a2 in the outer area of the ridge portion 122 in a contact state therewith, and then moves the pointer to another position a3 in the inner area of the ridge portion 122 in a contact state therewith (i.e., when the user does not detach the pointer from the position a2), the character selected by the previous rolling gesture (e.g., “A”) is not deleted.

Since the protrusion unit 120 protrudes from the mounting surface 140 at a verge of the touch unit 110 in the touch input device 100 according to the first embodiment, the user may recognize the touch unit 110 and the verge of the touch unit 110 not visibly but by tactile sense. The user may easily recognize the protrusion unit 120 by searching with a hand. Since the ridge portion 122 of the protrusion unit 120 has a closed loop shape (e.g., a circular shape), the user may instinctively sense the center of the touch unit 110. Thus, the user may accurately recognize the position of the central region by recognizing both side of the protrusion unit 120 even without watching the protrusion unit 120.

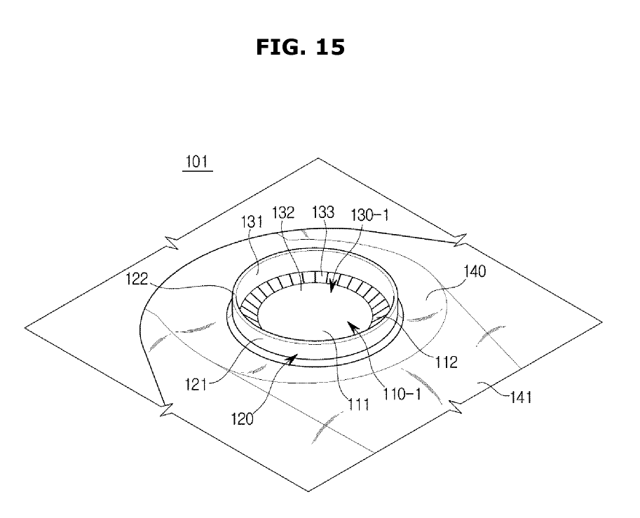

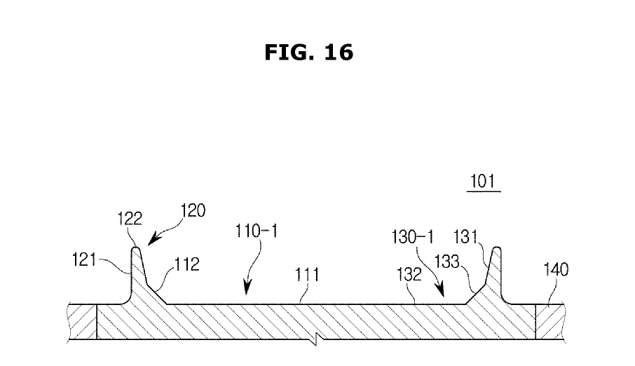

FIG. 15 is a perspective view illustrating a touch input device according to a second embodiment. FIG. 16 is a cross-sectional view illustrating the touch input device according to the second embodiment.

A recess unit 130-1 of a touch input device 101 according to the second embodiment may include a connection portion 133 connecting an inner side portion 131 with a bottom portion 132. The connection portion 133 may be formed to have a slanted surface or a curved surface having a negative curvature. Here, the negative curvature refers to a curvature of an inwardly concave surface viewed from the outside of the recess unit 130-1.

The connection portion 133 may be touch-inputtable. The user may input a touch signal by bringing a pointer into contact with the connection portion 133 or by moving the pointer on the connection portion 133 in a contact state therewith.

Since the connection portion 133 has the slanted surface or the curved surface having a negative curvature, a touch input by the user may be facilitated. The user may input a preset execution signal by touching or dragging the pointer on the region connecting the side portion 131 and the bottom portion 132.

The user may instinctively recognize a position of the connection portion 133 without watching the touch input device 101, for example, while watching the road or the display device. This is because the connection portion 133 has the slanted or curved surface and the inner side portion 131 is disposed on an outer circumferential area of the connection portion 133. Thus, the user may input a desired execution command without watching the connection portion 133.

A touch unit 110-1 according to the second embodiment may have a central touch portion 111 disposed on the bottom portion 132 and an outer touch portion 112 disposed on the connection portion 133. Touch pads disposed on the central touch portion 111 and the outer touch portion 112 may be integrated with each other or separately formed.

The touch pad disposed on the outer touch portion 112 may extend to the inner side portion 131. The user may input a preset execution command by touching not only the connection portion 133 but also the inner side portion 131. Alternatively, the connection portion 133 and the inner side portion 131 may receive different input signals. That is, an execution command input when the user touches the connection portion 133 may be different from that input when the user touches the inner side portion 131.

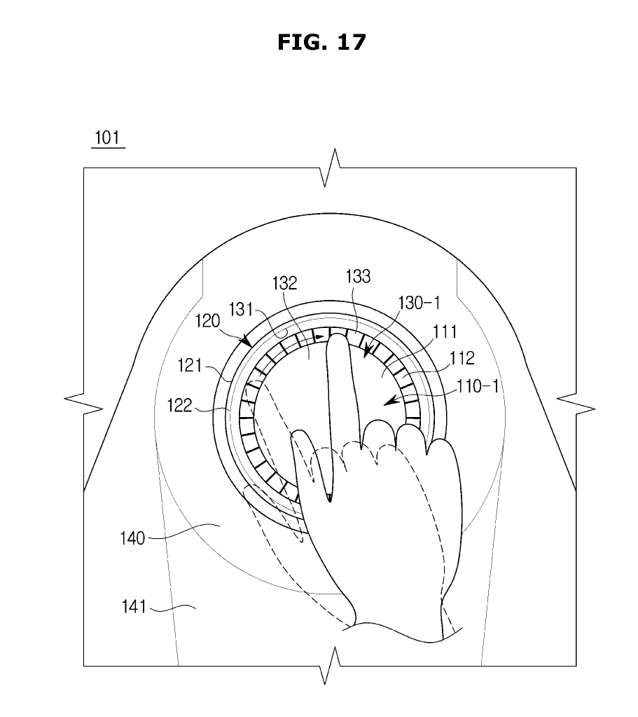

FIG. 17 is a plan view illustrating the touch input device according to the second embodiment for describing a rolling gesture input, as a touch gesture input.

A rolling operation refers to a touch input method in which the pointer moves in an arc of a circle about the center of the touch unit 110-1. A circling or spinning operation refers to a touch input method in which the pointer moves in a circle about the center of the touch unit 110. Although FIG. 17 illustrates the rolling operation, the circling or spinning operation may also be used.

The user may perform the rolling, circling, or spinning operation by touching the outer touch portion 112. In case of the rolling operation, different commands may be executed in accordance with a direction of a rolling touch input, a position where the rolling touch input is performed, a length of the rolling touch input, or the like when the user inputs the rolling touch by touching the outer touch portion 112.

For example, a touch input acquired when the pointer slides clockwise on the outer touch portion 112 may be different from that acquired when the pointer slides counterclockwise on the outer touch portion 112. In addition, when a touch input acquired when the pointer taps a left side of the outer touch portion 112 may be different from that acquired when the pointer taps a right side of the outer touch portion 112. When the pointer touches one point of the outer touch portion 112 and moves along the outer touch portion 112 in a contact state therewith, different touch inputs may be acquired in accordance with a position from which the pointer is detached.

The connection portion 133 (or the outer touch portion 112) may have scale marks spaced apart from each other at constant intervals. The scale marks may have an engraved or embossed pattern. By touching the connection portion 133 using a finger as the pointer, the user may instinctively recognize the number of scale marks via feelings of the finger without watching the scale marks. For example, when the user inputs a clockwise rolling touch on the connection portion 133 by 5 scale marks, the cursor shown on a display unit may move by 5 units rightward or clockwise.

Although the rolling, circling, and spinning operations are described above, a tap operation may also be input as a touch signal when the user touches one point of the outer touch portion 112. In this case, different commands may be input in accordance with the tap position of the user. For example, when the user touches an upper portion of the outer touch portion 112, the cursor may move upward.

The protrusion unit 120 may be touch-inputtable. For example, the user may input a touch signal by turning the outer side portion 121 of the protrusion unit 120 in a state of gripping the outer side portion 121. Since the protrusion unit 120 is fixed to the mounting surface 140, the protrusion unit 120 does not rotate, but the controller may recognize a sliding gesture of the hand of the user (as the pointer) in a contact state with the outer side portion 121.

In the same manner as in the first embodiment, the touch unit 110-1 may be disposed at various positions of the protrusion unit 120 and the recess unit 130-1. The user may input various commands as the touch unit 110-1 is disposed at various positions.

In this case, the ridge portion 122 of the protrusion unit 120 may be touch-inputtable. In addition, the user may make a rolling gesture by drawing a circle along the ridge portion 122 in a contact state with the ridge portion 122. As the rolling gesture is made on the ridge portion 122, one of the characters listed in the table of characters of the character table display region 620 of the display device 600 may be selected. The user may input the selected character by bringing the pointer into contact with the ridge portion 122, by moving the pointer to an inner portion of the touch input device 101 in a contact state therewith, and by detaching the pointer therefrom (i.e., flicking).

The user may delete the selected character by bringing the pointer into contact with the ridge portion 122, by moving the pointer to an outer portion of the touch input device 101 in a contact state therewith, and by detaching the pointer therefrom (i.e., flicking).

The methods of inputting and deleting the selected character are described above with reference to the first embodiment, and detailed descriptions thereof will not be given.

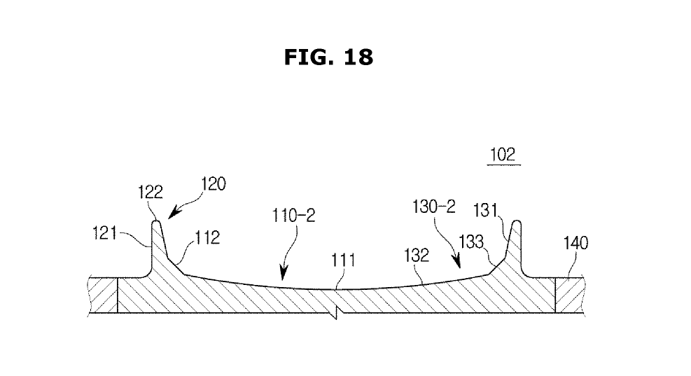

FIG. 18 is a cross-sectional view illustrating a touch input device according to a third embodiment.

A recess unit 130-2 of a touch input device 102 according to the third embodiment includes a bottom portion 132 having a concave surface. For example, the bottom portion 132 may have a concave curved surface. The bottom portion 132 has a concave curved surface with a constant curvature. However, tt is not limited thereto, such that the bottom portion 132 may have different curvatures. For example, the central region of the bottom portion 132 may have a smaller curvature (indicating a greater radius of curvature), and the outer region of the bottom portion 132 may have a greater curvature (i.e., a smaller radius of curvature).

A touch unit 110-2 may be disposed on the bottom portion 132. In this case, the touch unit 110-2 may have a concave shape formed on the bottom portion 132 and have the same shape as a concave portion of the bottom portion 132.

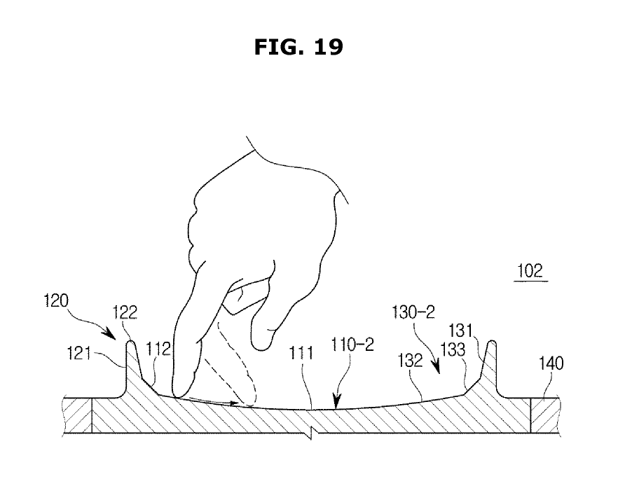

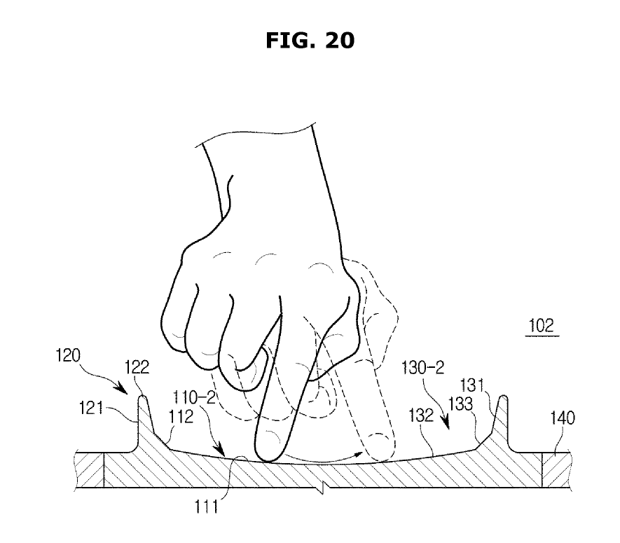

FIG. 19 is a diagram illustrating a trace of a finger when a user makes a vertical gesture. FIG. 20 is a diagram illustrating a trace of a finger when a user makes a horizontal gesture.

Since the touch unit 110-2 has a concave curved surface, user's touch sensitivity (feeling of manipulation) during the gesture input may be improved. The curved surface of the touch unit 110-2 may have a similar shape to traces of fingertip movement of a human while a wrist is fixed or while the wrist is rotated or twisted with the fingers stretched.

In comparison with the general planar touch unit, the touch unit 110-2 having the concave curved surface according to the third embodiment may be ergonomically designed. That is, the concave curved surface may not only improve the user's feeling of manipulation, but also reduce fatigue applied to the wrist. In addition, input accuracy may be improved in comparison with the gesture made to the planar touch unit.

Referring to FIG. 19, when the user vertically moves a finger, the gesture input may be performed via natural movement of the finger without moving or twisting other joints. Similarly, referring to FIG. 20, when the user horizontally moves the finger, the gesture input may be performed via natural movement of the finger and the wrist without excessively twisting the wrist. Since the touch unit 110-2 according to the third embodiment is ergonomically designed, user's fatigue may be reduced and skeletal disorders related to the wrist and other joints may be prevented.

In addition, the touch unit 110-2 may have a circular shape. When the touch unit 110-2 has a circular shape, the concave curved surface may be easily formed. Since the user senses a touch region of the circular touch unit 110-2 by tactile sense, the rolling or circling operation may be used.

In addition, since the touch unit 110-2 has the curved surface, the user may instinctively recognize the position of the finger on the touch unit 110-2. Since the touch unit 110-2 has the curved surface, the touch unit 110-2 has different slopes. Thus, the user may instinctively recognize the position of the finger on the touch unit 110-2 by sensing the slope through the finger.

These features may assist the user to make a desired gesture by providing feedback regarding the position of the finger on the touch unit 110-2 during the gesture input without watching the touch unit 110-2 and may also improve accuracy of the gesture input.

A touch pad used in the touch unit 110-2 having the curved surface may recognize a touch by an optical method. For example, an infrared light-emitting diode (IR LED) and a photodiode array may be disposed on the back surface of the touch unit 110-2. The IR LED and the photodiode array acquire an infrared image reflected by the finger and the controller extracts a touch point from the acquired infrared image.

A diameter and a depth of the touch unit 110-2 may be ergonomically designed. For example, the touch unit 110-2 may have a diameter of 50 mm to 80 mm.

In consideration of an average finger length of adults, a range of natural finger movement when the wrist is fixed may be 80 mm or less. When the diameter of the touch unit 110-2 is greater than 80 mm, the user may feel unnatural movement of the finger in drawing a circle in a swiping input unit 220 and excessively use the wrist.

When the diameter of the touch unit 110-2 is less than 50 mm, a touch area is reduced leading to reduction in diversity of inputtable gestures. In addition, gesture input errors may increase due to the reduced touch area.

In addition, when the touch unit 110-2 has a spherical surface, a depth/diameter ratio of the touch unit 110-2 may be in a range of 0.04 to 0.1. The depth/diameter ratio of the touch unit 110-2 indicates the curved degree of the curved surface of the touch unit 110-2. That is, as the depth/diameter ratio of the touch unit 110-2 increases, the touch unit 110-2 has a more curved surface. On the contrary, as the depth/diameter ratio of the touch unit 110-2 decreases, the touch unit 110-2 has less curved surface.

When the depth/diameter ratio of the touch unit 110-2 is greater than 0.1, the curvature of the concave shape increases causing inconvenience to the user during touch input. The concave shape of the touch unit 110-2 may have a similar curvature to that of a curve drawn by a fingertip of user's natural finger movement. However, when the depth/diameter ratio is greater than 0.1, excessive force is required for the finger movement while the user moves the finger along the curved surface of the touch unit 110-2, leading to unnatural feeling of manipulation. In addition, the user's finger may be detached from the curved surface when the user moves the finger carelessly. In this case, the gesture touch is terminated resulting in a recognition error.

In addition, as the depth of the touch unit 110-2 decreases, convenience of the curved surface to the user is negligible in comparison with the planar surface. When the depth/diameter ratio of the touch unit 110-2 is less than 0.04, the difference of feeling of manipulation is negligible in comparison with the gesture input to the planar touch unit.

The touch unit 110-2 according to the third embodiment may have a central touch portion 111 disposed on the bottom portion 132 and an outer touch portion 112 disposed on the connection portion 133. Touch pads disposed on the central touch portion 111 and the outer touch portion 112 may be integrated with each other or separately formed. The outer touch portion 112 is described above with reference to the second embodiment and may also be applied in the same manner.

The connection portion 133 may have a greater gradient than a tangential gradient of the curved surface of the bottom portion 132 at a border line between the connection portion 133 and the bottom portion 132 during a gesture input to the curved surface of the bottom portion 132. The user may instinctively recognize the touch region of a slope of the connection portion 133 since the gradient of the connection portion 133 is greater than the curved surface of the bottom portion 132.

A touch at an outer slope may not be recognized during the gesture input to the central touch portion 111. Thus, even when the pointer approaches the border line with the outer touch portion 112 during the gesture input to the central touch portion 111, the gesture input to the central touch portion 111 and the rolling gesture input to the outer touch portion 112 may not overlap.

In the same manner as in the first embodiment, the touch unit 110-1 may be disposed at various positions of the protrusion unit 120 and the recess unit 130-2. The user may input various commands as the touch unit 110-1 is disposed at various positions.

Here, the ridge portion 122 of the protrusion unit 120 may be touch-inputtable. In addition, the user may make a rolling gesture by drawing a circle along the ridge portion 122 in a contact state with the ridge portion 122. As the rolling gesture is made on the ridge portion 122, one of the characters listed in the table of characters of the character table display region 620 of the display device 600 may be selected. The user may input the selected character by bringing the pointer into contact with the ridge portion 122, by moving the pointer to an inner portion of the touch input device 101 in a contact state therewith, and by detaching the pointer therefrom (i.e., flicking).

The user may delete the selected character by bringing the pointer into contact with the ridge portion 122, by moving the pointer to an outer portion of the touch input device 101 in a contact state therewith, and by detaching the pointer therefrom (i.e., flicking).

The methods of inputting and deleting the selected character are described above with reference to the first embodiment, and detailed descriptions thereof will not be given.

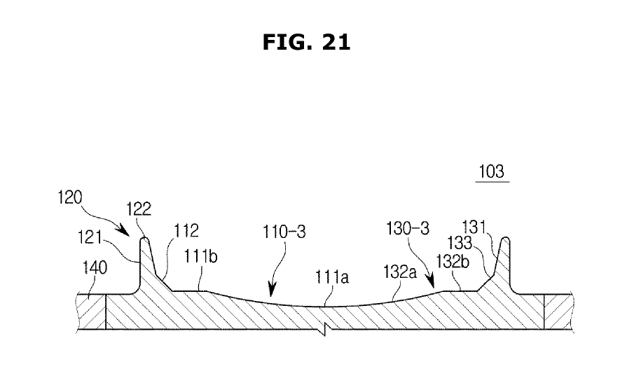

FIG. 21 is a cross-sectional view illustrating a touch input device according to a fourth embodiment.

A touch unit 110-3 of a touch input device 103 according to the fourth embodiment may have a first central touch portion 111a having a concave curved surface, a second central touch portion 111b surrounding the first central touch portion 111a and having a planar surface, and an outer touch portion 112 surrounding the second central touch portion 111b and having a slanted surface.

The bottom portion 132 may have a first bottom portion 132a disposed at the center and having a concave curved surface and a second bottom portion 132b surrounding the first bottom portion 132a and having a planar surface.

The first central touch portion 111a may be disposed on the first bottom portion 132a, the second central touch portion 111b may be disposed on the second bottom portion 132b, and the outer touch portion 112 may be disposed on the connection portion 133 of a recess unit 130-3.

The first central touch portion 111a, the second central touch portion 111b, and the outer touch portion 112 may independently receive touch signals. For example, the first central touch portion 111a may receive a gesture touch signal, the second central touch portion 111b may receive a direction touch signal, and the outer touch portion 112 may receive a rolling or circling touch signal.

Touch pads disposed on the first central touch portion 111a, the second central touch portion 111b, and the outer touch portion 112 may be integrated with one another or separately formed. When the touch pads are integrated, they may independently receive touch signals by using software.

Alternatively, the first central touch portion 111a, the second central touch portion 111b, and the outer touch portion 112 may execute a new command by combining touch signals respectively input to the touch unit 110-3. For example, when the user makes a flicking or swiping gesture on the first central touch portion 111a, an icon is shifted in a sub menu. When the user makes a flicking or swiping gesture on the first central touch portion 111a in a contact state with the second central touch portion 111b, an icon of a main menu may be shifted. This touch input may simplify an operation for changing the icon of the main menu after an exit from the sub menu to the main menu thereby changing the icon of the main menu in the sub menu. For example, a music playback menu may be directly shifted to a navigation menu.

In the same manner as in the first embodiment, the touch unit 110-3 may be disposed at various positions of the protrusion unit 120 and the recess unit 130-3. The user may input various commands as the touch unit 110-3 is disposed at various positions.

In this case, the ridge portion 122 of the protrusion unit 120 may be touch-inputtable. The user may make a rolling gesture by drawing a circle along the ridge portion 122 in a contact state with the ridge portion 122. As the rolling gesture is made on the ridge portion 122, one of the characters listed in the table of characters of the character table display region 620 of the display device 600 may be selected. The user may input the selected character by bringing the pointer into contact with the ridge portion 122, by moving the pointer to an inner portion of the touch input device 103 in a contact state therewith, and by detaching the pointer therefrom (i.e., flicking).

In addition, the user may delete the selected character by bringing the pointer into contact with the ridge portion 122, by moving the pointer to an outer portion of the touch input device 103 in a contact state therewith, and by detaching the pointer therefrom (i.e., flicking).

The methods of inputting and deleting the selected character are described above with reference to the first embodiment, and detailed descriptions thereof will not be given.

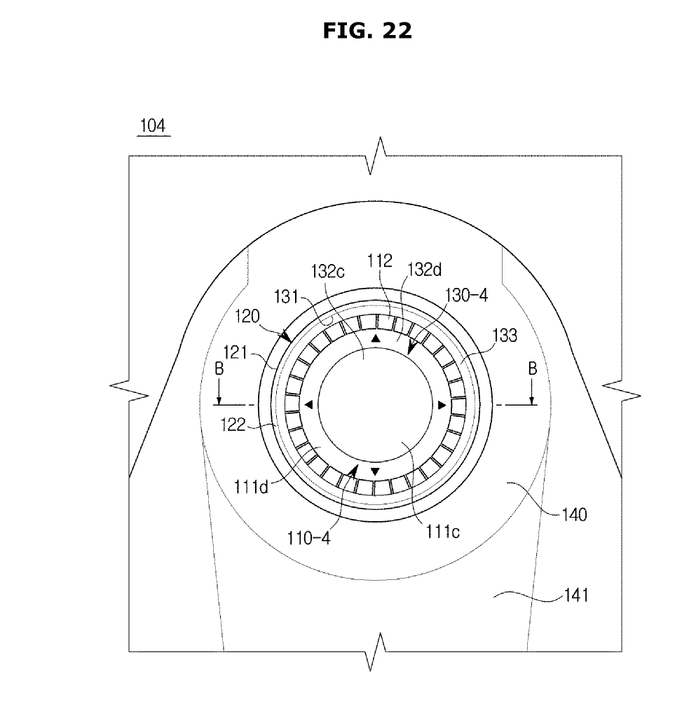

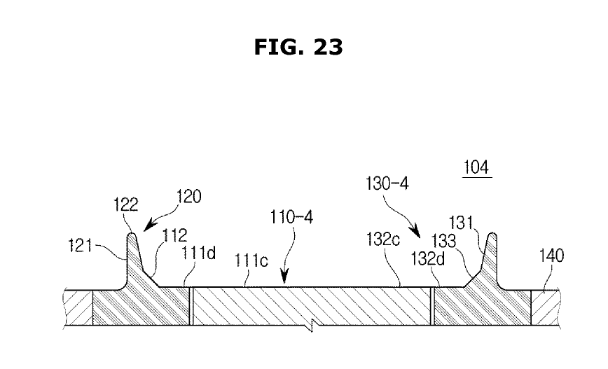

FIG. 22 is a plan view illustrating a touch input device according to a fifth embodiment. FIG. 23 is a cross-sectional view taken along line B-B of FIG. 22.

A touch unit 110-4 of a touch input device 104 according to the fifth embodiment may have a first central touch portion 111c, a second central touch portion 111d surrounding the first central touch portion 111c, and an outer touch portion 112 surrounding the second central touch portion 111d and having a slanted surface.

The bottom portion 132 may have a first bottom portion 132c disposed at the center and a second bottom portion 132d surrounding the first bottom portion 132c. The first bottom portion 132c and the second bottom portion 132d may be separately provided. Thus, the first bottom portion 132c may move independently of the second bottom portion 132d. The second bottom portion 132d may also move independently of the first bottom portion 132c.

The first central touch portion 111c may be disposed on the first bottom portion 132c, the second central touch portion 111d may be disposed on the second bottom portion 132d, and the outer touch portion 112 may be disposed on the connection portion 133 of the recess unit 130-3.

The first central touch portion 111c and the second central touch portion 111d may be physically separated from each other. Thus, touch pads disposed on the first central touch portion 111c and the second central touch portion 111d are separately provided.

The first central touch portion 111c and the second central touch portion 111d may move independently. For example, the first central touch portion 111c may employ a pressing structure, and the second central touch portion 111d may employ a 4-way tilting structure, (e.g., up/down/left/right). In this case, the user may move the cursor of the display device by tilting the second central touch portion 111d by applying a pressure thereto. In addition, a menu where the cursor of the display device is located may be selected by clicking the first central touch portion 111c by applying a pressure thereto.

In addition, the first central touch portion 111c and the second central touch portion 111d may have different movements. For example, the first central touch portion 111c may employ a tilting structure, and the second central touch portion 111d may employing a pressing structure.

Both the first central touch portion 111c and the second central touch portion 111d may not move. In this case, different touch pads physically separated from each other are used for the first central touch portion 111c and the second central touch portion 111d.

The first central touch portion 111c, the second central touch portion 111d, and the outer touch portion 112 may independently receive touch signals. For example, the first central touch portion 111c may receive a gesture touch signal, the second central touch portion 111d may receive a direction touch signal, and the outer touch portion 112 may receive a rolling or circling touch signal.

In the same manner as in the first embodiment, the touch unit 110-4 according to the fifth embodiment may be disposed at various positions of the protrusion unit 120 and the recess unit 130-4. The user may input various commands as the touch unit 110-4 is disposed at various positions.

In this case, the ridge portion 122 of the protrusion unit 120 may be touch-inputtable. In addition, the user may make a rolling gesture by drawing a circle along the ridge portion 122 in a contact state with the ridge portion 122. As the rolling gesture is made on the ridge portion 122, one of the characters listed in of the character table display region 620 of the display device 600 may be selected. The user may input the selected character by bringing the pointer into contact with the ridge portion 122, by moving the pointer to an inner portion of the touch input device 104 in a contact state therewith, and by detaching the pointer therefrom (i.e., flicking).

Further, the user may delete the selected character by bringing the pointer into contact with the ridge portion 122, by moving the pointer to an outer portion of the touch input device 104 in a contact state therewith, and by detaching the pointer therefrom (i.e., flicking).

The methods of inputting and deleting the selected character are described above with reference to the first embodiment, and detailed descriptions thereof will not be given.

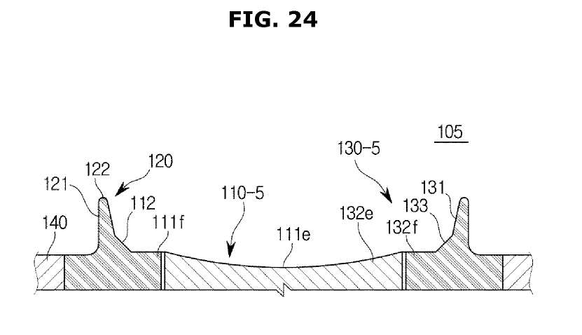

FIG. 24 is a cross-sectional view illustrating a touch input device according to a sixth embodiment.

A touch unit 110-5 of a touch input device 105 according to the sixth embodiment may have a first central touch portion 111e having a concave curved surface, a second central touch portion 111f surrounding the first central touch portion 111e and having a planar surface, and an outer touch portion 112 surrounding the second central touch portion 111f and having a slanted surface.

The bottom portion 132 may have a first bottom portion 132e disposed at the center and having a concave curved surface and a second bottom portion 132f surrounding the first bottom portion 132e and having a planar surface.

The first central touch portion 111e may be disposed on the first bottom portion 132e, the second central touch portion 111f may be disposed on the second bottom portion 132f, and the outer touch portion 112 may be disposed on the connection portion 133 of a recess unit 130-5.

The first central touch portion 111e and the second central touch portion 111f may be physically separated from each other. Thus, touch pads disposed on the first central touch portion 111e and the second central touch portion 111f are separately provided.

In the same manner as in the first embodiment, the touch unit 110-5 according to the sixth embodiment may be disposed at various positions of the protrusion unit 120 and the recess unit 130-5. The user may input various commands as the touch unit 110-5 is disposed at various positions.

Here, the ridge portion 122 of the protrusion unit 120 may be touch-inputtable. In addition, the user may make a rolling gesture by drawing a circle along the ridge portion 122 in a contact state with the ridge portion 122. As the rolling gesture is made on the ridge portion 122, one of the characters listed in the table of characters of the character table display region 620 of the display device 600 may be selected. The user may input the selected character by bringing the pointer into contact with the ridge portion 122, by moving the pointer to an inner portion of the touch input device 105 in a contact state therewith, and by detaching the pointer therefrom (i.e., flicking).

The user may delete the selected character by bringing the pointer into contact with the ridge portion 122, by moving the pointer to an outer portion of the touch input device 105 in a contact state therewith, and by detaching the pointer therefrom (i.e., flicking).

The methods of inputting and deleting the selected character are described above with reference to the first embodiment, and detailed descriptions thereof will not be given.

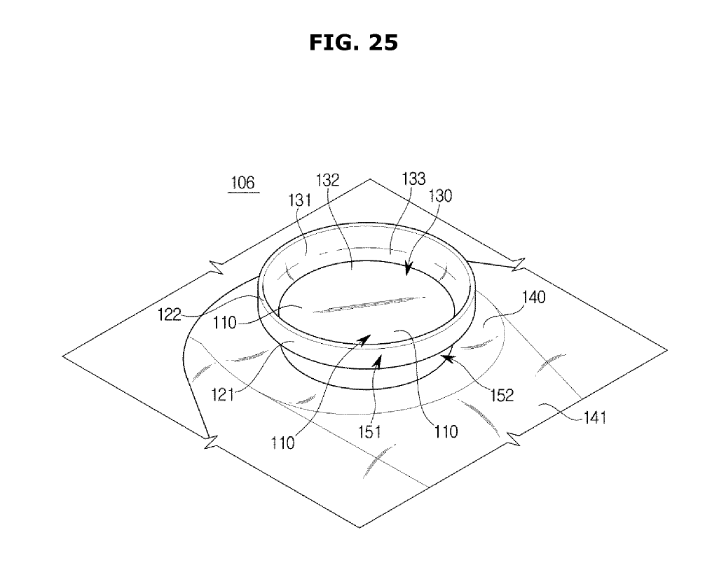

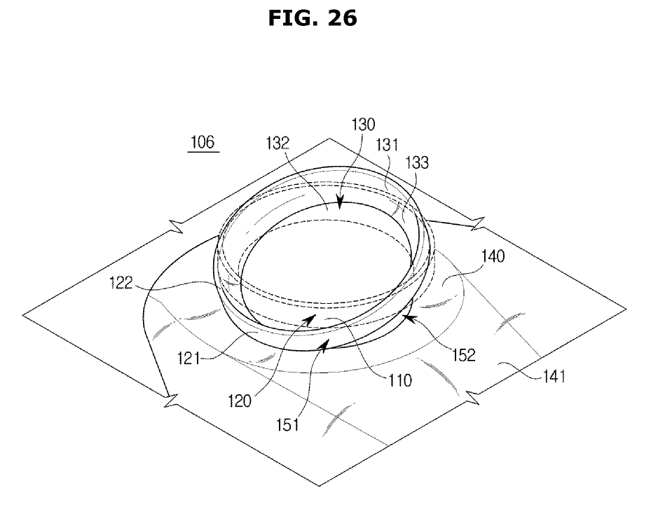

FIG. 25 is a perspective view illustrating a touch input device according to a seventh embodiment. FIG. 26 is a perspective view illustrating the touch input device according to the seventh embodiment for describing manipulation thereof.

A touch input device 106 according to the seventh embodiment may be slanted or tilted. The touch input device 106 may have a single structure including a protrusion unit 120 and a recess unit 130 and may be tilted with respect to the mounting surface 140. The touch input device 106 may perform a pressing operation.

The touch input device 106 may include a body 151 which has the protrusion unit 120 and the recess unit 130 and a support 152 which supports the body 151. The support 152 may support a lower part of the body 151 and be tilted with respect to the mounting surface 140. Structures for the tilting operation are well known in the art, and thus, detailed descriptions thereof will not be given herein.

The touch input device 106 may tilt to at least one direction about a central axis. For example, the touch input device 106 may tilt forward, backward, leftward, and rightward about the central axis. According to the present disclosure, the touch input device 106 may tilt to more directions. In addition, when the center of the touch input device 106 is pressed, the touch unit 110 may be pressed in a balanced state.

The user may input a preset execution signal by pressing or tilting the touch input device 106. For example, the user may execute a selected menu by pressing the center of the touch input device 106 and may move the cursor upward by pressing an upper portion of the touch input device 106.

Although not shown in the drawings, the touch input device 106 may include various parts related to operation thereof. The touch input device 106 may include a structure pressed or tilted in the afore-mentioned five directions. However, the structure is well known in the art, and detailed descriptions thereof will not be given herein.

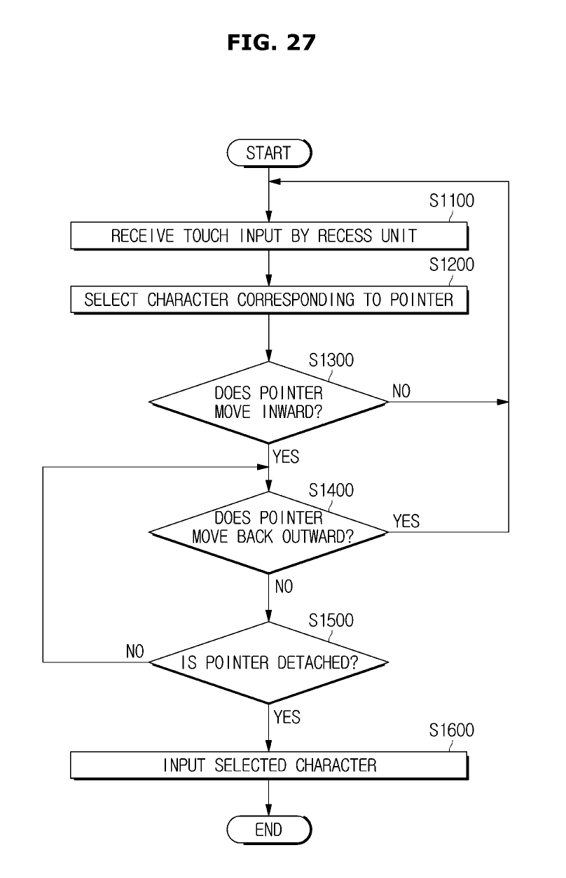

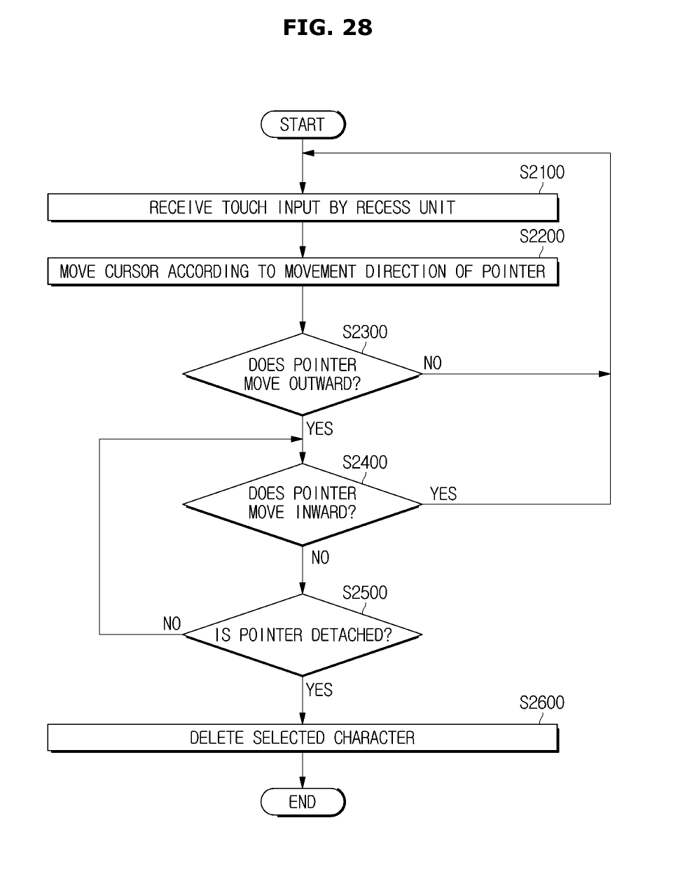

Hereinafter, methods of inputting or deleting a character by using the touch input device will be described with reference to FIGS. 27 and 28. FIG. 27 is a flowchart for describing a method of inputting a character by using a touch input device according to the present disclosure. FIG. 28 is a flowchart for describing a method of deleting a character by using a touch input device according to the present disclosure. Constituent elements of the touch input device according to the first embodiment will be described by way of example of constituent elements of the touch input devices of FIGS. 27 and 28.

Referring to FIG. 27, the ridge portion 122 of the touch input device 100 receives a touch input from the user (S1100). The touch input received by the ridge portion 122 from the user may be a rolling gesture made on the ridge portion 122.

Then, the controller selects a character corresponding to the user's touch input among a plurality of characters (S1200). In this regard, a table of characters including the plurality of characters may be displayed on a separate display device 600. The user may search for a desired character to be input via the rolling gesture made on the ridge portion 122 while staring the table of characters.

When the pointer, which is a touch input point of the user, moves to a position closer to the center (i.e., moves inward) of the touch input device 100 (“Yes” of S1300), the controller determines the movement as an input of the selected character (S1600). The input character may be separately displayed on the display device 600.

For example, when the user brings the pointer into contact with the ridge portion 122, moves the pointer to the inner side portion 131 of the touch input device in a contact state therewith, and detaches the pointer from the inner side portion 131 (“Yes” of S1500), the character selected by the previous rolling gesture may be input.

As another example, when the user brings the pointer into contact with the ridge portion 122, moves the pointer to the touch unit 110 via the inner side portion 131 of the touch input device in a contact state therewith, and detaches the pointer from the touch unit 110 (“Yes” of S1500), the character selected by the previous rolling gesture may be input.

As another example, when the user brings the pointer into contact with one position a1 of the ridge portion 122, moves the pointer inward to another position a2 of the ridge portion 122 in a contact state therewith, and detaches the pointer from position a2 (“Yes” of S1500), the character selected by the previous rolling gesture may be input.

When the pointer, which is a touch input point of the user, moves to one position closer to the center of the touch input device 100 (i.e., moves inward) (“Yes” of S1300) and then moves to another position farther from the center of the touch input device 100 (i.e., moves outward) (“Yes” of S1400), the controller determines the movement as cancellation of character input.

For example, when the user brings the pointer into contact with the ridge portion 122, moves the pointer to the inner side portion 131 of the touch input device in a contact state therewith, and then moves the pointer back to the ridge portion 122 in a contact state therewith (i.e., when the user does not detach the pointer from the inner side portion 131) (“No” of S1500), the character selected by the previous rolling gesture is not input.

As another example, when the user brings the pointer into contact with the ridge portion 122, moves the pointer to the touch unit 110 via the inner side portion 131 of the touch input device in a contact state therewith, and then moves the pointer back to the ridge portion 122 via the inner side portion 131 in a contact state therewith (i.e., when the user does not detach the pointer from the touch unit 110) (“No” of S1500), the character selected by the previous rolling gesture is not input.

As another example, when the user brings the pointer into contact with one position a1 of the ridge portion 122, moves the pointer inward to another position a2 of the ridge portion 122 in a contact state therewith, and then moves the pointer outward to another position a3 of the ridge portion 122 in a contact state therewith (i.e., when the user does not detach the pointer from the position a2) (“No” of S1500), the character selected by the previous rolling gesture is not input.

Referring to FIG. 28, when the character correction mode starts to delete a previously input character, the ridge portion 122 of the touch input device 100 receives a touch input from the user (S2100). The touch input received by the ridge 122 from the user may be a rolling gesture made on the ridge portion 122.

Then, the controller moves the cursor displayed on the display device 600 in accordance with a direction of the touch input performed by the user (S2200). Here, the cursor may be displayed on the display device 600 to correspond to one of the previously input characters, and the user may search for a desired character to be deleted via the rolling gesture made on the ridge portion 122 while watching the cursor.

When the pointer, which is a touch input point of the user, moves to a position farther to the center (i.e., moves outward) of the touch input device 100 (“Yes” of S2300), the controller determines the movement as a deletion of the selected character (S2600).

For example, when the user brings the pointer into contact with the ridge portion 122, moves the pointer to the outer side portion 121 of the touch input device in a contact state therewith, and detaches the pointer from the outer side portion 121 (“Yes” of S2500), the character selected by the previous rolling gesture may be deleted.

As another example, when the user brings the pointer into contact with one position a1 of the ridge portion 122, moves the pointer outward to another position a2 of the ridge portion 122 in a contact state therewith, and detaches the pointer from the position a2 (“Yes” of S2500), the character selected by the previous rolling gesture may be deleted.

When the pointer, which is a touch input point of the user, moves to one position farther from the center of the touch input device 100 (i.e., moves outward) (“Yes” of S2300) and then moves to another position closer to the center of the touch input device 100 (i.e., moves inward) (“Yes” of S2400), the controller determines the movement as cancellation of character deletion.

For example, when the user brings the pointer into contact with the ridge portion 122, moves the pointer to the outer side portion 121 of the touch input device in a contact state therewith, and then moves the pointer back to the ridge portion 122 in a contact state therewith (i.e., when the user does not detach the pointer from the outer side portion 121) (“No” of S2500), the character selected by the previous rolling gesture is not deleted.

As another example, when the user brings the pointer into contact with one position a1 of the ridge portion 122, moves the pointer outward to another position a2 of the ridge portion 122 in a contact state therewith, and then moves inward the pointer to position a3 of the ridge portion 122 in a contact state therewith (i.e., when the user does not detach the pointer from position a2) (“No” of S2500), the character selected by the previous rolling gesture is not deleted.

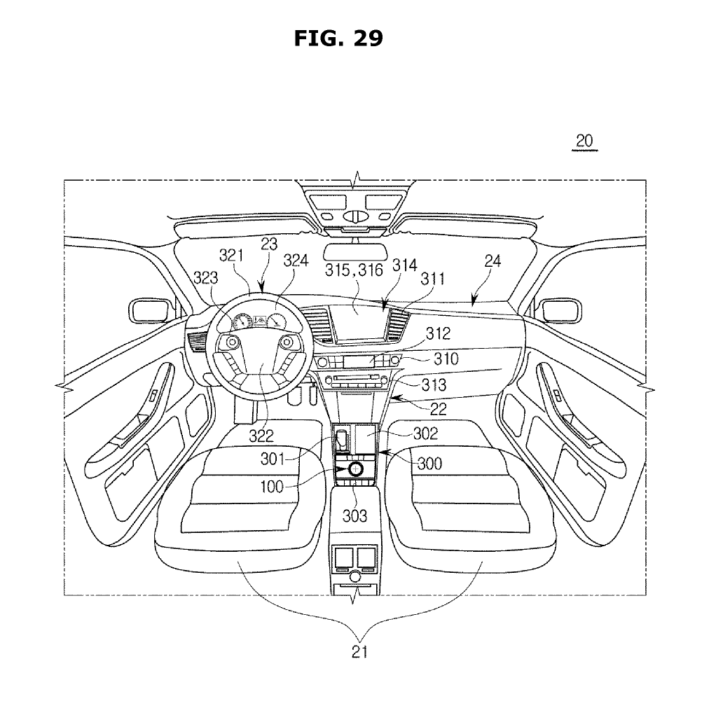

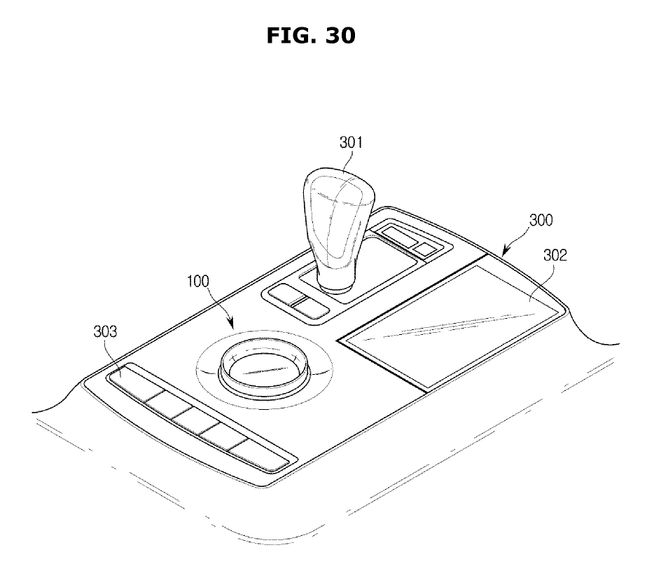

FIG. 29 is an interior view of a vehicle including the touch input device according to the first embodiment. FIG. 30 is a perspective view illustrating a gear box including the touch input device according to the first embodiment.

Referring to FIG. 29, a vehicle 20 may include seats 21 on which a driver and a passenger sit, a gear box 300, and a dashboard provided with a center fascia 22 and a steering wheel 23.

The center fascia 22 may have an air conditioner 310, a clock 312, an audio device 313, an audio video navigation (AVN) device 314, and the like.

The air conditioner 310 maintains the inside of the vehicle 20 in a comfortable state by adjusting temperature, humidity, cleanness of air, and air flow inside the vehicle 20. The air conditioner 310 may include at least one discharge port 311 installed in the center fascia 22 and configured to discharge air. The center fascia 22 may have a button or dial to control the air conditioner 310, and the like. The driver or passenger may control the air conditioner 310 by using the button disposed at the center fascia 22.

The clock 312 may be disposed near the button or dial to control the air conditioner 310.

The audio device 313 may include a control panel on which a plurality of buttons to perform functions of the audio device 313 are disposed. The audio device 313 may provide a radio mode to provide radio functions and a media mode to reproduce audio files of various storage media including the audio files.

The AVN device 314 may be embedded in the center fascia 22 of the vehicle 20 or protrude from the dashboard 24. The AVN device 314 performs an overall operation of audio functions, video functions, and navigation functions in accordance with user manipulation. The AVN device 314 may include an input unit 315 to receive the user command regarding the AVN device 314 and a display 316 to display a screen related to the audio functions, video functions, or navigation functions. The audio device 313 may be omitted if functions of the audio device 313 overlap those of the AVN device 314.

The steering wheel 23 controls a driving direction of the vehicle 20 and includes a rim 321 which is gripped by the driver and a spoke 322 which is connected to a steering device of the vehicle 20 and connects the rim 321 with a hub of a rotating shaft for steering. According to the present disclosure, the spoke 322 may include a manipulator 323 to control various devices of the vehicle 20, for example, an audio device.

The dashboard 24 may further include an instrument cluster 324 to provide various driving-related information such as a driving speed of the vehicle 20, mileage, an engine RPM, a fuel level, a coolant temperature, various warnings, or the like to the driver, and a glove compartment 325 for miscellaneous storage.

The gear box 300 may be mounted between a driver's seat and a passenger's seat in the vehicle 20 and may include manipulation devices required while the driver drives the vehicle 20.

Referring to FIG. 30, the gear box 300 may include a transmission lever 301 to shift gears of the vehicle 20, a display device 302 to control performance of functions of the vehicle 20, and buttons 303 to operate various devices of the vehicle 20. In addition, the touch input device 100 according to the first to third embodiments may be installed in the gear box 300.

The touch input device 100 according the present disclosure may be installed in the gear box 300 such that the driver may operate the touch input device 100 while looking straight ahead. For example, the touch input device 100 may be installed under the transmission lever 301. The touch input device 100 may also be installed in the center fascia 22, the front passenger's seat, or back seats.

Although not shown in the drawings, the touch input device 100 and the transmission lever 301 may be integrated with each other. In this case, a rolling gesture may be made by rolling a top portion of the transmission lever 301.

The touch input device 100 may access display devices installed in the vehicle 20 to select or execute various icons displayed on the display devices.

The display devices may be installed in the audio device 313, the AVN device 314, the instrument cluster 324, or the like in the vehicle 20. Alternatively, the display device 302 may be installed at the gear box 300, if necessary. A display device may be connected to a head up display (HUD) device or rear view mirrors.

For example, the touch input device 100 may move a cursor or execute an icon, which is displayed on a display device. The icon may include a main menu, a select menu, a settings menu, and the like. Furthermore, a navigation system may be manipulated, vehicle driving conditions may be set, or peripheral devices of the vehicle 20 may be manipulated via the touch input device 100.

The display device of the vehicle 20 may be the display device 600 described above with reference to the first to seventh embodiments.

As is apparent from the above description, according to the touch input device and the vehicle according to the present disclosure, the user may input or correct a character using the touch input device without staring at the touch input device, i.e., while the user is looking at the display device.

According to the touch input device and the vehicle of the present disclosure, accuracy of character input may be improved by inputting the character at a correct location using a sense of a finger.

According to the touch input device and the vehicle of the present disclosure, the driver may accurately and quickly correct a character during manipulation of a navigation system or an audio device while driving while looking straight ahead for driving.

Although exemplary embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A touch input device comprising:
a protrusion unit protruding from a mounting surface and receiving a touch signal from a user;
a recess unit disposed inside the protrusion unit; and
a controller configured to determine whether to input or delete a character in accordance with an input direction of the touch signal.

2. The touch input device according to claim 1, wherein when the touch signal is input toward a first position which is closer to a center of the recess unit, the controller determines the touch signal as a character input.

3. The touch input device according to claim 2, wherein when a pointer corresponding to the touch signal moves toward the first position and is then detached from the touch input device, the controller determines the movement of the pointer as the character input.

4. The touch input device according to claim 3, wherein when the pointer corresponding to the touch signal moves toward the first position and then moves to a second position which is farther from the center of the recess unit, the controller determines the movement of the pointer as a cancellation of the character input.

5. The touch input device according to claim 1, wherein when the touch signal is input toward a second position, the controller determines the touch signal as a character deletion.

6. The touch input device according to claim 5, wherein when a pointer corresponding to the touch signal moves toward the second position and is then detached from the touch input device, the controller determines the movement of the pointer as the character deletion.

7. The touch input device according to claim 6, wherein when the pointer corresponding to the touch signal moves toward the second position and then moved to a third position which is closer to the center of the recess unit, the controller determines the movement of the pointer as a cancellation of the character deletion.

8. The touch input device according to claim 1, wherein the controller selects one of a plurality of characters in accordance with the input direction of the touch signal.

9. The touch input device according to claim 8, wherein the controller selects one of the plurality of characters in accordance with a direction of a user's rolling gesture.

10. The touch input device according to claim 9, wherein when the character is selected by the rolling gesture and the touch signal is input toward a position closer to a center of the recess unit, the controller determines the touch signal as a character input.

11. The touch input device according to claim 1, wherein the controller moves a cursor displayed on a display device in accordance with the input direction of the touch signal.

12. The touch input device according to claim 11, wherein the controller moves the cursor displayed on the display device in accordance with a direction of a user's rolling gesture.

13. The touch input device according to claim 12, wherein when the cursor is placed at one character by the user's rolling gesture and the touch signal is input toward a second position, the controller determines the touch signal as a character deletion.

14. The touch input device according to claim 1, wherein the protrusion unit has a cylindrical shape.

15. The touch input device according to claim 2, wherein when the touch signal is input from the protrusion unit to the recess unit, the controller determines the touch signal as the character input.

16. The touch input device according to claim 2, wherein when the touch signal is input from the second position to the first position, the controller determines the touch signal as the character input.

17. The touch input device according to claim 1, wherein the protrusion unit has a column shape.

18. A vehicle comprising:
a touch input device comprising a protrusion unit which protrudes from a mounting surface and receives a touch signal from a user and a recess unit which is disposed inside the protrusion unit; and
a controller configured to determine whether to input or delete a character in accordance with an input direction of the touch signal.

19. The vehicle according to claim 18, further comprising a display device,
wherein the controllers operates the display device in accordance with the touch signal input to the touch input device.

20. The vehicle according to claim 19, wherein when the touch signal is input toward a first position which is closer to a center of the recess unit, the display device displays the character corresponding to the touch signal.

21. The vehicle according to claim 19, wherein when the touch signal is input toward a second position which is farther from a center of the recess unit, the display device deletes the character corresponding to the touch signal.

22. A method for controlling a touch input device, the method comprising:
receiving, by a protrusion unit protruding from a mounting surface and by a recess unit disposed inside the protrusion unit, a touch signal from a user; and
determining, by a controller, whether to input or delete a character in accordance with an input direction of the touch signal,
wherein the step of determining comprises:
determining, when a pointer corresponding to the touch signal moves toward a first position which is closer to a center of the recess unit and is then detached from the touch input device, the movement of the pointer as a character input.

23. The method of claim 22, wherein the step of determining further comprises:
determining, when the pointer corresponding to the touch signal moves toward the first position and then moves to a second position which is farther from the center of the recess unit, the movement of the pointer as a cancellation of the character input.
